(19) United States
(12) Patent Application Publication
(10) Pub. No.: US 2022/0070231 A1
(43) Pub. Date: Mar. 3, 2022

(54) INFORMATION PROCESSING DEVICE, COMMUNICATION METHOD, AND COMMUNICATION SYSTEM

(71) Applicants: Takashi HASEGAWA, Kanagawa (JP); Koichi INOUE, Kanagawa (JP); Takafumi TAKEDA, Tokyo (JP)

(72) Inventors: Takashi HASEGAWA, Kanagawa (JP); Koichi INOUE, Kanagawa (JP); Takafumi TAKEDA, Tokyo (JP)

(21) Appl. No.: 17/458,539

(22) Filed: Aug. 27, 2021

(30) Foreign Application Priority Data
Aug. 28, 2020 (JP) 2020-144933

(51) Int. Cl. H04L 29/06; G06Q 10/06; G06Q 10/10

(52) U.S. Cl. CPC H04L 65/1093; H04L 65/403; G06Q 30/016; G06Q 10/063114; G06Q 10/105; G06Q 10/063112

(57) ABSTRACT

A communication method executed by an information processing device is provided. The information processing device is configured to communicate with a second information processing device associated with a first user via a network, and includes a processor and a memory storing programmed instructions that, when executed by the processor, are operable for performing the communication method. The communication method includes causing the information processing device to display a list of second users while a call is in progress with the second information processing device; causing the information processing device to receive a selection of one of the second users displayed on the list; and causing the information processing device to transmit a request for participation in the call with the second information processing device to a third information processing device, the third information processing device being associated with the selected one of the second users.

### CROSS-REFERENCE TO RELATED APPLICATION

The present application is based on and claims priority under 35 U.S.C. § 119 to Japanese Patent Application No. 2020-144933, filed on Aug. 28, 2020, the content of which is incorporated herein by reference in its entirety.

### BACKGROUND OF THE INVENTION

### 1. Field of the Invention

The disclosures discussed herein relate to an information processing device, a communication method, and a communication system.

### 2. Description of the Related Art

Remote concierge service (remote customer service) has recently become more available from the viewpoint of streamlining of store operations and improvement of the efficiency. The remote concierge service allows customers to connect from a store terminal to an explainer terminal used by a person (concierge) having a specialized skill at a remote service center via the Internet or the like in the event that the customers have to wait in line for the customer service because employees in the store are serving other customers. The customers can thus receive the customer service through a video call with an explainer at a remote service center.

Further, unmanned stores where employees do not serve customers have recently been operated in addition to manned stores where employees serve customers. Even such unmanned stores have store terminals. Customers can receive customer service by visiting unmanned stores and using the store terminals to make a video call to an explainer at the service center.

However, depending on the interests of the customer, the explainer may be pressed to answer something on a particular matter for which they do not possess the requisite knowledge during the course of the conversation with the customer. In such cases, the explainer may be able to ask a nearby explainer about information the customer desires to know, but such a nearby explainer may not always be knowledgeable about what the customer desires to know.

In the case of a video conference, it is possible to allow another participant to join the video conference during the video conference (see, for example, Patent Document 1). Patent Document 1 discloses a method of allowing a different participant to join a conference during the conference while limiting the number of participants without registering participants in the conference in advance.

However, according to such a related art method, a second user, such as an explainer, cannot transmit a request for participation in a call with a first user, such as a customer, to another second user, such as another explainer. For example, even when an explainer is questioned by a customer about matters that the explainer does not know, and there is another explainer who is knowledgeable about the matters being inquired by the customer at some other store or service center, there is no method for calling such an explainer who is knowledgeable about the matters being inquired by the customer. Hence, the explainer who is questioned by the customer must resolve the matters on his or her own, or cannot provide sufficient information to the customer. In other words, since the explainers are normally serving customers remotely, the explainers do not have sufficient information about other explainers, and the explainers do not know which explainer would be able to solve questions inquired by the customer.

### RELATED ART DOCUMENT

### Patent Document

[Patent Document 1] Japanese Unexamined Patent Application Publication No. 2014-027433

### SUMMARY OF THE INVENTION

According to one aspect of embodiments of the present invention, a communication method executed by an information processing device is provided. The information processing device is configured to communicate with a second information processing device associated with a first user via a network, and includes a processor and a memory storing programmed instructions that, when executed by the processor, are operable for performing the communication method. The communication method includes

causing the information processing device to display a list of second users while a call is in progress with the second information processing device;

causing the information processing device to receive a selection of one of the second users displayed on the list; and

causing the information processing device to transmit a request for participation in the call with the second information processing device to a third information processing device, the third information processing device being associated with the selected one of the second users.

### BRIEF DESCRIPTION OF THE DRAWINGS

FIG. 1 is a diagram illustrating an outline of operations of a communication system in which an explainer terminal operated by an explainer in communication with a store terminal operated by a customer calls another explainer while a call is in progress;

FIG. 2 is a diagram illustrating an overall configuration of a communication system according to a present embodiment;

FIG. 3 is an image diagram illustrating a situation in which a customer at a store and an explainer at a service center are conversing with each other by a remote video call;

FIG. 4 is a diagram illustrating a hardware configuration of each terminal and each device that form the communication system according to the present embodiment;

FIG. 5 is a functional block diagram illustrating functional components of the communication system according to the present embodiment;

FIG. 6 is a functional block diagram illustrating functional components of the communication system according to the present embodiment;

FIG. 7A is a schematic diagram illustrating an explainer management table, and FIG. 7B is a schematic diagram illustrating a skill group management table;

FIG. 8A is a schematic diagram illustrating an authentication management table, and FIG. 8B is a schematic diagram illustrating a terminal status management table;

FIG. 9A is a schematic diagram illustrating a destination list management table, FIG. 9B is a schematic diagram illustrating a session management table, and FIG. 9C is a schematic diagram illustrating a communication information management table;

FIG. 10A is a schematic diagram illustrating a system update information management table, FIG. 10B is a schematic diagram illustrating a business management table, and FIG. 10C is a schematic diagram illustrating a group management table;

FIG. 11A is a schematic diagram illustrating a terminal management table and FIG. 11B is a schematic diagram illustrating a skill management table;

FIG. 12A is a schematic diagram illustrating a login information management table, FIG. 12B is a schematic diagram illustrating a subgroup management table, and FIG. 12C is a schematic diagram illustrating a user update information management table;

FIG. 13 is a sequence diagram illustrating a process of registering service information;

FIG. 14 is a diagram illustrating a login screen displayed by an administrator terminal;

FIG. 15 is a diagram illustrating a store list screen displayed by the administrator terminal;

FIG. 16 is a diagram illustrating an explainer list screen displayed by the administrator terminal;

FIG. 17 is a diagram illustrating a group list screen displayed by the administrator terminal;

FIG. 18 is a diagram illustrating an explainer information editing screen displayed by the administrator terminal;

FIG. 19 is a diagram illustrating a group information editing screen displayed by the administrator terminal;

FIG. 20 is a diagram illustrating a store information editing screen displayed by the administrator terminal;

FIG. 21 is a sequence diagram illustrating a process of preparing a video call of a store terminal and specifically illustrating a process of acquiring service information;

FIG. 22 is a sequence diagram illustrating a process of preparing a video call of a store terminal and specifically illustrating a process of acquiring an operating status of each terminal;

FIG. 23 is a flowchart illustrating a process of preparing a video call of a store terminal and specifically illustrating a process of determining an operating status of a group of explainer terminals on a per skill basis;

FIGS. 24A to 24D are diagrams each illustrating a screen displayed on a store terminal;

FIG. 25 is a sequence diagram illustrating a process of starting a video call;

FIG. 26 is a sequence diagram illustrating a detailed process of communication establishment control;

FIG. 27 is a sequence diagram illustrating an example of a process of calling another explainer terminal from an explainer terminal in communication with a store terminal;

FIGS. 28A and 28B are diagrams illustrating an example of a list of other explainers displayed on an explainer terminal;

FIG. 29 is a diagram illustrating an example of an incoming dialog displayed on another explainer terminal that receive a call from an explainer terminal in communication with a store terminal; and

FIG. 30 is a sequence diagram illustrating an example of a process in which an explainer terminal displays a change in an operating status of another explainer terminal while a call is in progress in real time on the list.

### DETAILED DESCRIPTION OF THE PREFERRED EMBODIMENTS

The embodiments of a communication system and a communication method performed by the communication system are described with reference to the accompanying drawings.

### <Outline of Overall Operation>

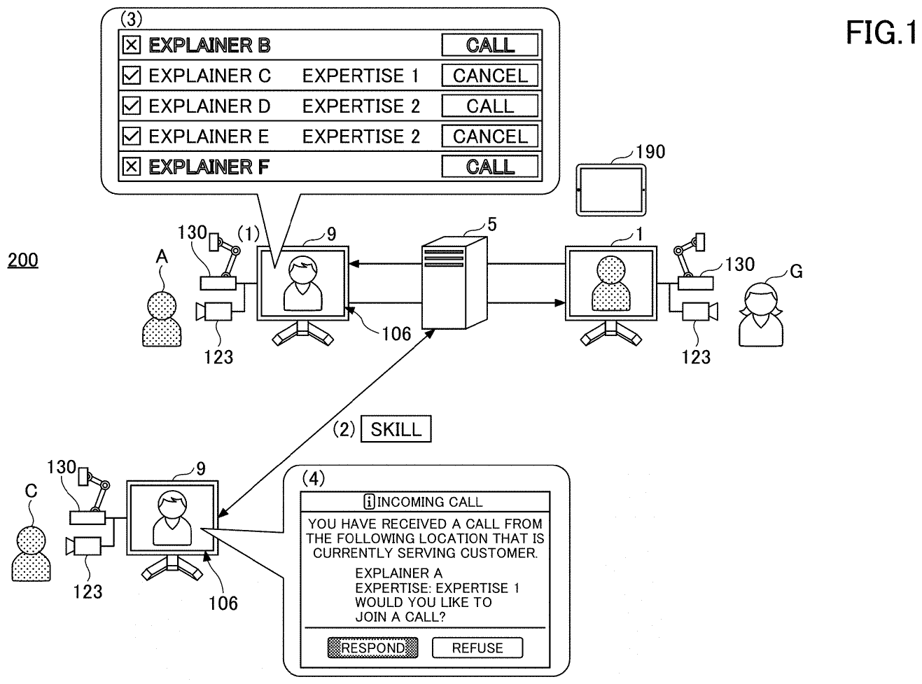

FIG. 1 is a diagram illustrating an outline of operations of a communication system 200 when an explainer A calls another explainer C while a call is underway between the explainer terminal 9 operated by the explainer A and the store terminal 1 operated by the customer. As illustrated in FIG. 1, remote communication is performed between the explainer terminal 9 operated by the explainer A and the store terminal 1 operated by the customer. Remote communication is a conference held at a remote location. Conferences are gatherings of people who gather for consultation, discussion, and the like. Conferences can take a variety of forms, including serving customers, meetings, gatherings, preparatory meetings, study sessions, classes, seminars, and presentations. Conferences may not necessarily be two-way communications.

It is assumed that the explainer terminal 9 is disposed at the service center, and the store terminal 1 is disposed at the store. The explainer terminal 9 is operated by the explainer A and the store terminal 1 is operated by a customer G who has come to the store. A web camera 123 and a document camera 130 are connected to each of the explainer terminal 9 and the store terminal 1. A touch panel 190 is connected to the store terminal 1 so that the customer G can write information by hand.

(1) As illustrated in FIG. 1, while a call is in progress (while serving a customer), the explainer terminal 9 displays an image (movie or still image) captured by a store terminal 1 through the Web camera 123 or the document camera 130 on the display 106. Similarly, the store terminal 1 displays an image (movie or still image) captured by the explainer terminal 9 through the Web camera 123 or the document camera 130 on a display 106. The explainer A and the customer G can communicate with each other while seeing each other's faces.

(2) A different explainer C is waiting at the service center or at the store. Another explainer terminal 9 operated by the explainer C transmits an operating status and the skill of the explainer C to the explainer terminal 9 of the explainer A through a communication management device 5. The skill is expertise of the explainers at the service center. For example, in the case of a travel agency, domestic travel, international travel, or weddings may be the field of expertise of the explainers. Thus, the explainer terminal 9 of the explainer A retains information about the operating status of the other explainer terminal 9 and the skills of the other explainer in real time.

(3) If the explainer A is asked about matters (field) unfamiliar with the explainer A while serving the customer G, the explainer A displays information about the retained operating statuses of other explainers and skills of the other explainers (a list of other explainers). The explainer A selects one of the other explainers who is likely to be familiar with the questions asked by the customer G.

(4) When the explainer A selects, for example, the explainer C, the explainer terminal 9 of the explainer A requests the communication management device 5 to call the explainer C. The communication management device 5 calls an explainer terminal 9 of the explainer C based on a communication ID of the explainer C, and the explainer terminal 9 of the explainer C displays an incoming dialog. The incoming dialog displays a skill required by the customer G, so that the explainer C can decide whether to join the call. By the participation of the explainer C in the call, the explainer C can describe matters (field) with which the explainer A is not familiar. The customer G is able to obtain answers to the questions as a result.

As described above, according to the present embodiment, the explainer terminal 9 (of the explainer A in the above case) can display a list of other explainer terminals 9 and call the selected one of the other explainer terminals 9. Thus, the explainer terminal 9 that is in communication (conversation) with a customer enables another explainer terminal 9 to join the call (or communication).

### Terminology

The first user is a person who purchases or is likely to purchase goods or service. In the present embodiment, the first user is referred to as a customer. The first user includes not only visitors to a store but also persons who operate store terminals at any location, such as their home or a cafe. The function of a store terminal can be provided by causing an information processing device to download a predetermined application (program). The customer may be referred to as a user, or guest, or the like.

The second user is a person who provides information to the first user. According to the present embodiment, the second user is referred to as an explainer. The explainer is a person who explains the content and meaning of matters in an easy-to-understand manner. The second user may be referred to as an operator, a concierge, a curator, an explainer, or an advisor. The function of an explainer terminal can be provided by causing an information processing device to download a predetermined application (program). Therefore, the difference between the functions of the store terminal and the explainer terminal is provided by different applications.

A second information processing device is a terminal operated by a customer at the store, and a third information processing device is a terminal disposed at a location of another explainer. The store terminals and explainer terminals are collectively referred to as communication terminals.

“Participation” means joining or participation in conferences, and the like. According to the present embodiment, participation means that an explainer later joins remote communication while a call is in progress.

“A call being in progress” means that an explainer and a customer are able to talk at any time, but does not require that they actually talk, for example. That is, the customer may look at a document in a status of being ready to talk. “A call being in progress” may include a case where the store terminal and the explainer terminal are in communication insofar as the store terminal and the explainer terminal are enabled to make a call.

Expertise is a specific field in which some people have relatively extensive experience and knowledge. For example, expertise in travel includes domestic travel, overseas travel, weddings, and the like, expertise in life insurance includes non-life insurance, medical insurance or corporate insurance, and the like, expertise in loans includes housing loans or car loans, and the like, expertise in investments includes stocks (domestic or foreign), funds, FX or futures for investments, and the like. The expertise is not limited to these examples, of course.

### <Overall Configuration of Communication System>

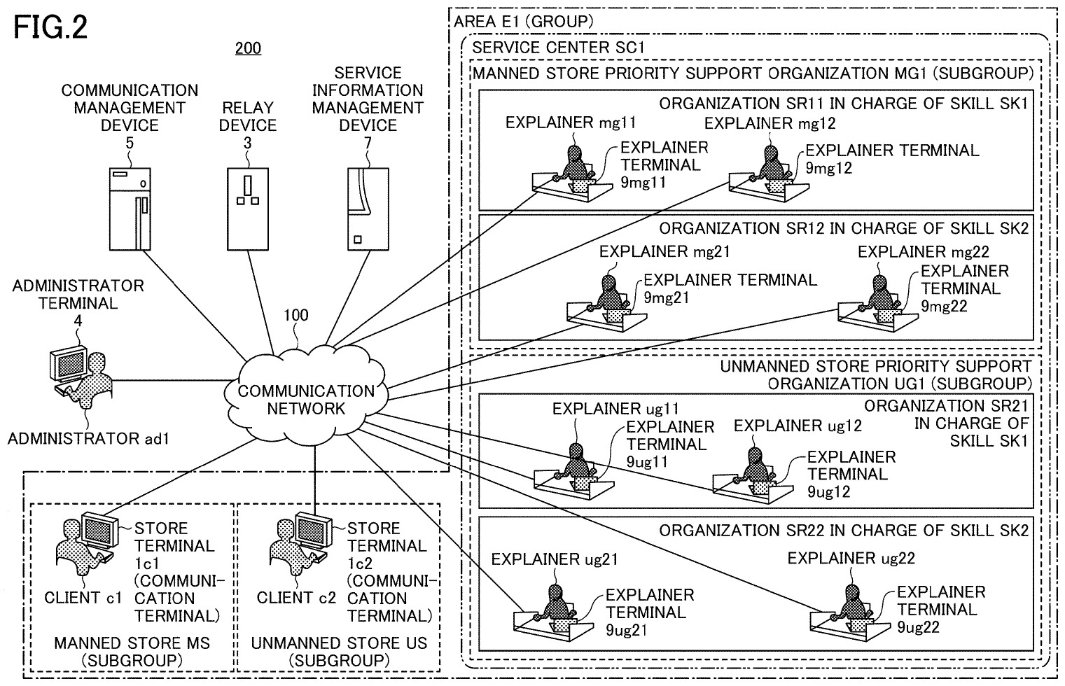

An overall configuration of the communication system will be described with reference to FIG. 2. FIG. 2 is a diagram illustrating an overall configuration of a communication system according to an embodiment of the present invention. In this configuration, customers, a travel agency selling travel products to the customers, and a system provider providing a remote concierge system are present.

The travel agency operates manned and unmanned branches and service centers in multiple areas, such as the Kanto and Kansai areas. In FIG. 2, the travel agency is illustrated as operating a manned store MS, an unmanned store US, and a service center SC1 in area E1. The manned store MS is a store where employees serve customers. The unmanned store US is a store where employees do not serve customers. In FIG. 2, only one manned store MS and one unmanned store US are illustrated, but the numbers of manned stores MS and the unmanned stores US may each be two or more.

In the manned store MS, employees usually provide information on travel products to customers who visit the store. However, when employees are serving customers, the employees may be unable to serve new customers. In the unmanned store US, there are no employees who can serve customers in the first place. In such cases, a customer may use a store terminal 1c1 in the manned store MS or a store terminal 1c2 in the unmanned store US to access an explainer terminal of any one of explainers at a service center SC1 via communication network 100 such as the Internet, so that the customer can receive a remote customer service associated with travel products from the explainer.

The store terminals 1c1 and 1c2 are composed of personal computers (PCs). Multiple store terminals may be provided in the manned store MS and unmanned store US. Hereinafter, in the case of a generic name of multiple store terminals, such as store terminals 1c1 and 1c2, the term “store terminal 1” may be used. The store terminal 1 is an information processing device that operates a general-purpose OS (Windows (registered trademark), Mac OS (registered trademark), Android (registered trademark), iOS (registered trademark), and the like. Examples of the information processing device include, but are not limited to, smartphones, mobile phones, tablet PCs, notebook PCs, personal digital assistants (PDAs), and the like. The store terminal 1 may be a terminal device dedicated to the communication system 200.

The service center SC1 includes a manned store priority support organization MG1 to preferentially receive a call start request to start remote customer service from the store terminal 1c1 of the manned store MS, and an unmanned store priority support organization UG1 to preferentially receive a call start request to start remote customer service from the store terminal 1c2 of the unmanned store US. Note that there may be three or more than priority response organizations.

In addition, the manned store priority support organization MG1 includes an organization SR11 in charge of skill SK1 and the organization SR12 in charge of skill SK2. For example, skill SK1 is the ability of an explainer who can make proposals about cruises, and skill SK2 is the ability of an explainer who can make proposals about weddings. Similarly, the unmanned store priority support organization UG1 includes an organization SR21 in charge of skill SK1 and an organization SR22 in charge of skill SK2. In other words, the manned store priority support organization MG1 and the unmanned store priority support organization UG1 have organizations SR11 and SR21 (or organizations SR12 and SR22) in which explainers having the same skills are present. Note that there may be three or more skills and organizations in charge of skills.

Further, in the manned store priority support organization MG1, explainers mg11 and mg12 having the skill SK1 are present in the organization SR11 in charge of the skill SK1. The explainer mg11 uses the explainer terminal 9mg11, and the explainer mg12 uses the explainer terminal 9mg12.

In addition, explainers mg21 and mg22 having skill SK2 are present in the organization SR12 in charge of skill SK2. The explainer mg21 uses the explainer terminal 9mg21, and the explainer mg22 uses the explainer terminal 9mg22.

Similarly, in the unmanned store priority support organization UG1, the explainers ug11 and ug12 having the skill SK1 are present in the organization SR21 in charge of the skill SK1. The explainer ug11 uses an explainer terminal 9ug11, and the explainer ug12 uses an explainer terminal 9ug12. In addition, explainers ug21 and ug22 having skill SK2 are present in the organization SR22 in charge of skill SK2. The explainer ug21 uses explainer terminal 9ug21, and the explainer ug22 uses explainer terminal 9ug22.

Three or more explainers may be present in each organization in charge (SR11, SR12, SR21, SR22). In this case, an explainer terminal is assigned to each of the three or more explainers. Hereinafter, if the explainer terminal represents a generic term for multiple explainer terminals such as 9mg11, 9mg12, 9mg21, 9mg22, 9ug11, 9ug12, 9ug21, and 9ug22, such an explainer terminal is referred to as an “explainer terminal 9”. The explainer terminal 9 is an information processing device which operates a general-purpose OS (Windows (registered trademark), Mac OS (registered trademark), Android (registered trademark), iOS (registered trademark), or the like. Examples of such an information processing device include, but are not limited to, smartphones, mobile phones, tablet PCs, notebook PCs, personal digital assistants (PDAs), and the like. The explainer terminal 9 may be a terminal device dedicated to the communication system 200.

The travel agency also has an administrator ad1 who administers terminals in each service area. The administrator ad1 accesses a service information management device 7 through the communication network 100 using an administrator terminal 4 and sets various service information. The service information is information concerning the processing and setting of each terminal of the travel agency, and the administrator terminal 4 is configured by a PC.

A customer c1 and a customer c2 are persons who visit the manned store MS and unmanned store US, respectively.

The system provider manages and operates a relay device 3, a communication management device 5, and a service information management device 7. The relay device 3, the communication management device 5, and the service information management device 7 are computers such as servers. The relay device 3 relays image data and sound data when performing a video call between any of the store terminal 1 and the explainer terminal 9. The communication management device 5 centrally manages login authentication from the store terminal 1 and the explainer terminal 9, communication statuses of the store terminal 1 and the explainer terminal 9, destination lists, and a communication status of the relay device 3. The service information management device 7 manages various set service information. The relay device 3, the communication management device 5, and the service information management device 7 will be described in detail later.

The store terminal 1, the administrator terminal 4, the explainer terminal 9, the relay device 3, the communication management device 5, and the service information management device 7 can be connected to the communication network 100 such as the Internet.

The relay device 3, the communication management device 5, and the service information management device 7 may be constructed by a single computer, or may be constructed by a plurality of computers to which divided parts (functions or means) are allocated.

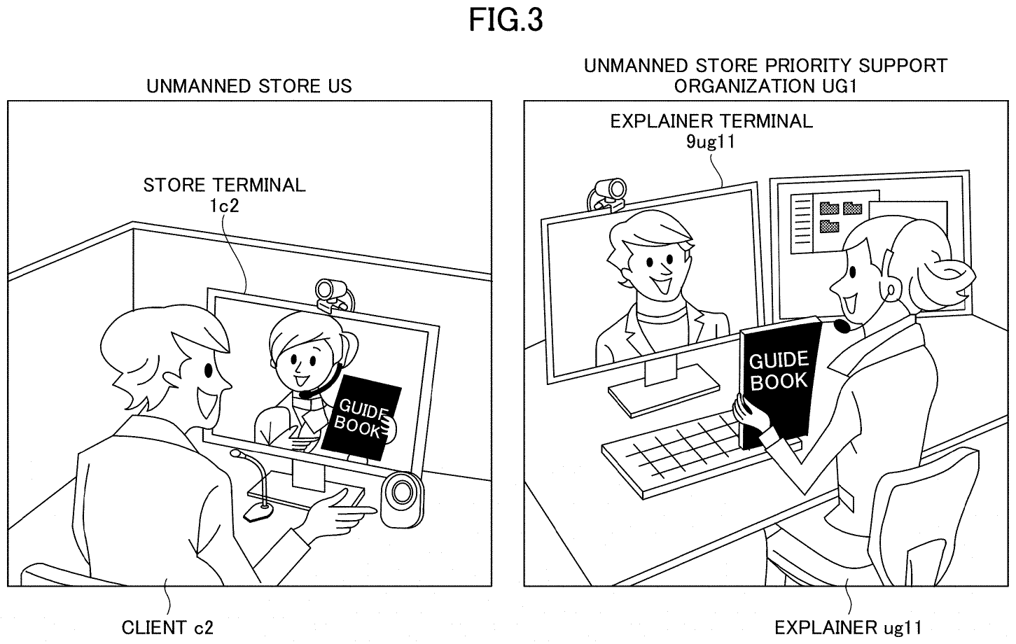

FIG. 3 is an image diagram illustrating a situation in which a customer at the store and an explainer at the service center are conversing with each other by a remote video call. In FIG. 3, a customer c2 who has come to the unmanned store US uses the store terminal 1c2 and an explainer ug11 at the unmanned store priority support organization UG1 uses the explainer terminal 9ug11. In this manner, the customer c2 can receive an explanation on the travel products by remote customer service.

### [Communication System Hardware Configuration]

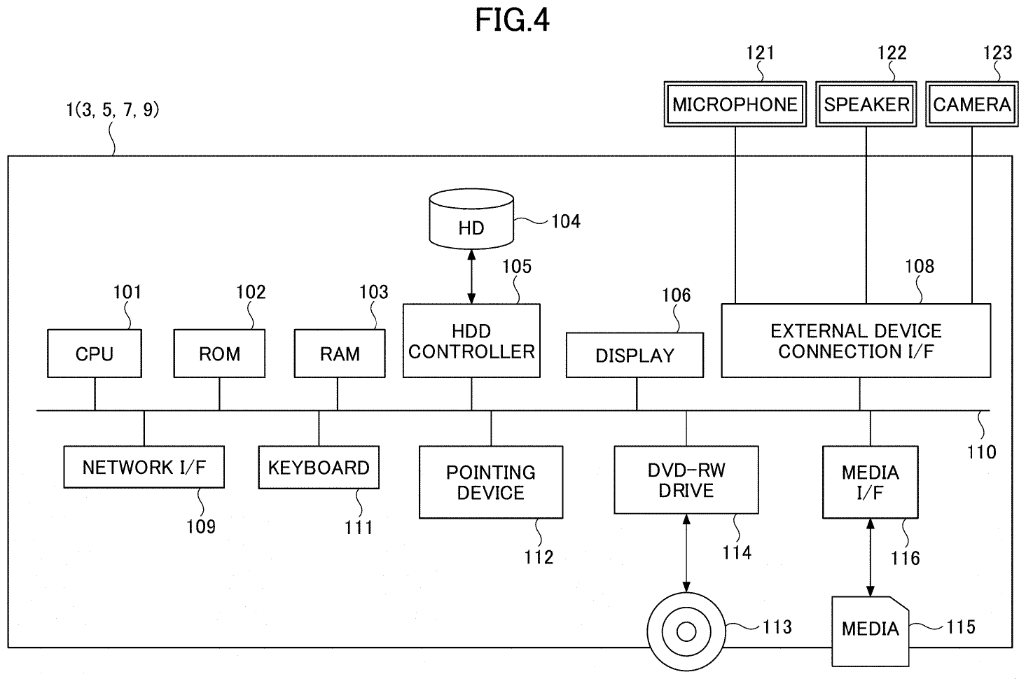

Subsequently, the hardware configuration of each terminal (the store terminal 1, the administrator terminal 4, the explainer terminal 9, and each device (the relay device 3, the communication management device 5, and the service information management device 7) constructing the communication system 200 illustrated in FIG. 2 will be described with reference to FIG. 4. In the present embodiment, since each terminal and each device have the same configuration, only the hardware configuration of the store terminal 1 will be described, and illustration of the hardware configurations of the other terminals and the device will be omitted.

As illustrated in FIG. 4, the store terminal 1 is configured by a computer, which includes a CPU 101, a ROM 102, a RAM 103, an HD 104, an HDD (hard disk drive) controller 105, a display 106, an external device connection I/F (interface) 108, a network I/F 109, a bus line 110, a keyboard 111, a pointing device 112, a DVD-RW (Digital Versatile Disk Rewritable) drive 114, and a media I/F 116.

Of these, the CPU 101 controls operation of the entire computer. The ROM 102 stores a program used to drive the CPU 101, such as an IPL. The RAM 103 is used as a work area of the CPU 101. The HD 104 stores various data such as a program. The HDD controller 105 controls reading or writing of various data from or to the HD 104 according to the control of the CPU 101. The display 106 displays various types of information such as cursors, menus, windows, characters, or images. The external device connection I/F 108 is an interface for connecting various external devices. In this case, the external device may be, for example, a USB (Universal Serial Bus) memory or a printer. The network I/F 109 is an interface for performing data communication using the communication network 100. The bus line 110 is an address bus, a data bus, or the like for electrically connecting components such as the CPU 101 illustrated in FIG. 4.

The keyboard 111 is a type of input unit having a plurality of keys for inputting characters, numbers, various instructions, and the like. The pointing device 112 is a type of an input unit for selecting and executing various instructions, selecting a processing target, moving a cursor, and the like. The DVD-RW drive 114 controls reading or writing of various data from or to the DVD-RW 113 as an example of a removable recording medium. The DVD-RW is not limited to the DVD-RW described, but may include a DVD-R, a Blu-ray Disc (registered trademark, Blu-ray Disc), and the like. The media I/F 116 controls the reading or writing (storing) of data from or to the recording medium 115, such as a flash memory.

A microphone 121 as an example of a sound collector, a speaker 122 as an example of a sound output device, and a camera 123 as an example of an imaging device are connected to an external device connection I/F. In FIG. 4, the microphone 121, the speaker 122, and the camera 123 are illustrated as external devices. However, the microphone may be an internal device that does not go through the external device connection I/F.

### <Functional Configuration of Communication System>

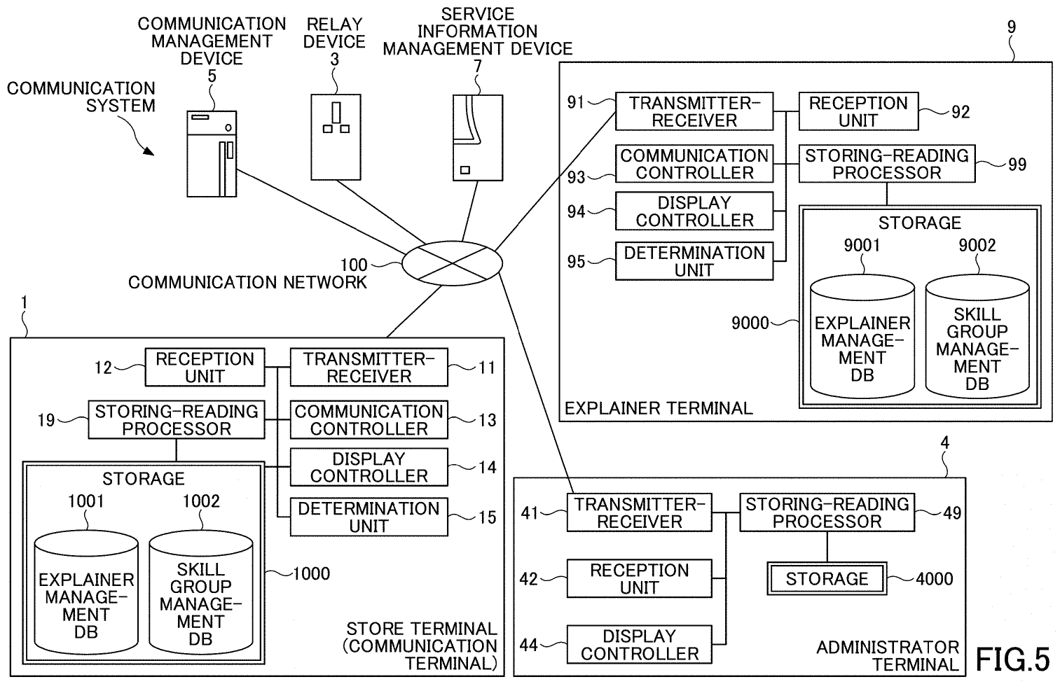

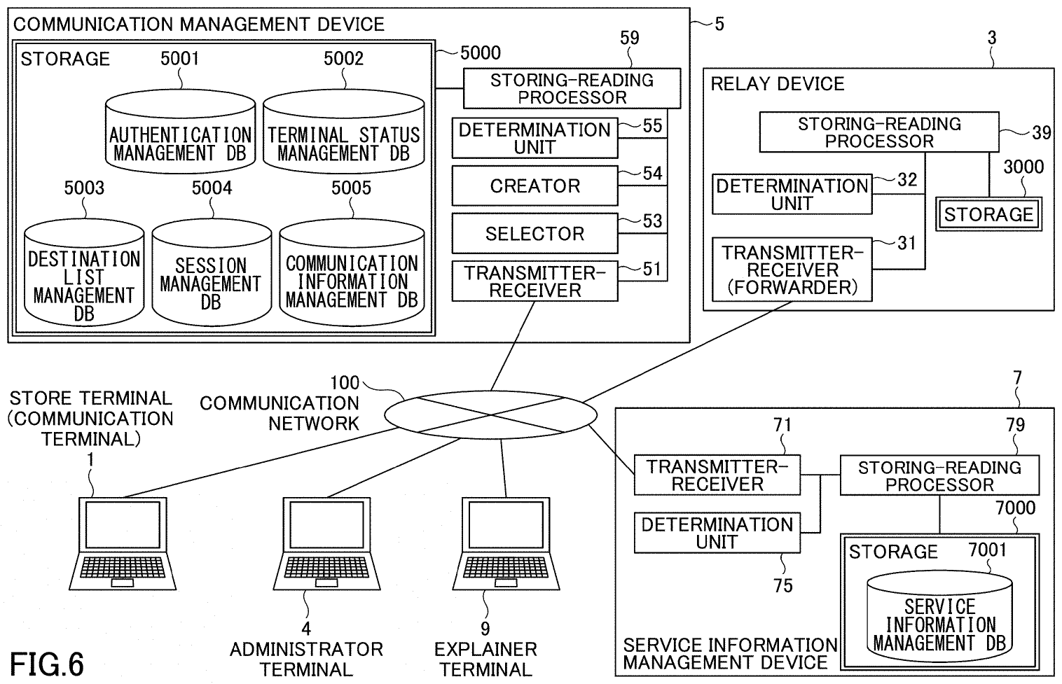

Next, a functional configuration of the communication system according to a present embodiment will be described with reference to FIGS. 4 to 12C. FIGS. 5 and 6 are functional block diagrams illustrating the communication system according to the present embodiment.

### <Functional Configuration of Store Terminal>

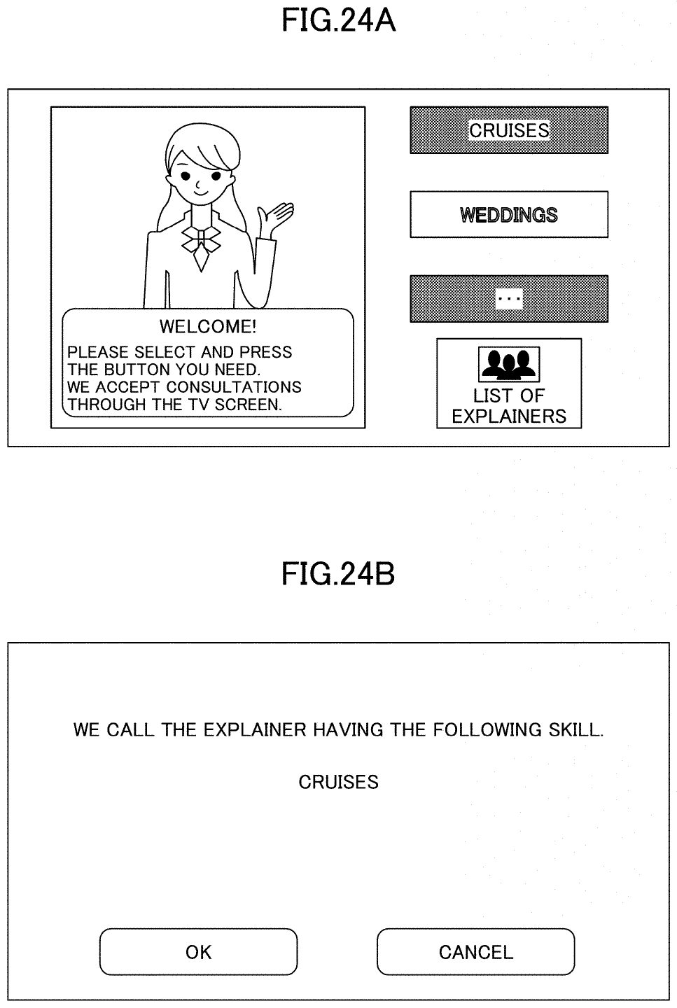

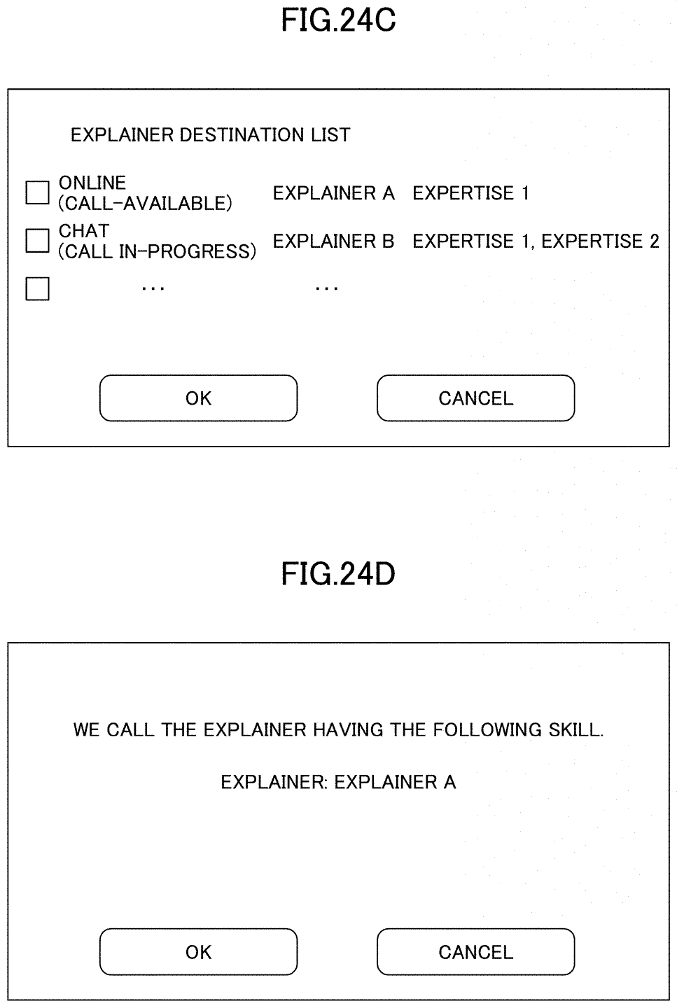

First, the functional configuration of the store terminal 1 will be described with reference to FIGS. 4 and 5. As illustrated in FIG. 5, the store terminal 1 includes a transmitter-receiver 11, a reception unit 12, a communication controller 13, a display controller 14, a determination unit 15, and a storing-reading processor 19. Each of these components is a function or a functional unit implemented by executing instructions from the CPU 101 according to a program loaded in the RAM 103 from the HD 104. The store terminal 1 includes a storage unit 1000 constructed by the RAM 103 and the HD 104 illustrated in FIG. 4. An explainer management DB 1001 (an example of a user management DB) and a skill group management DB 1002 are constructed in the storage unit 1000. Each of information managed by the explainer management DB 1001 and the skill group management DB 1002 is included in the client information transmitted from the service information management device 7 in step S19, which will be described later. The store terminal 1 then uses each of the information managed by the explainer management DB 1001 and the skill group management DB 1002 to display a screen illustrated in FIGS. 24A to 24D, which will be described later.

### (Explainer Management Table)

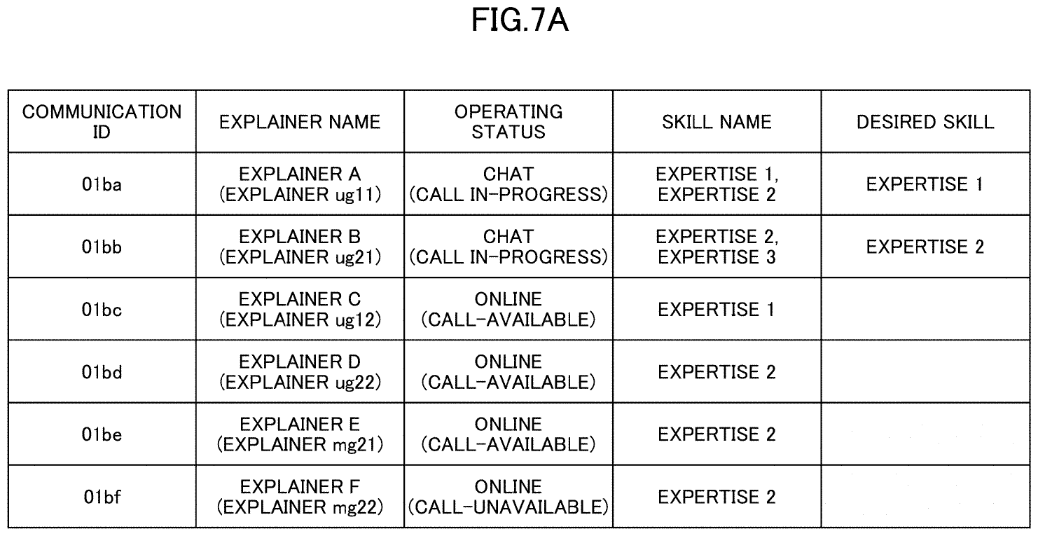

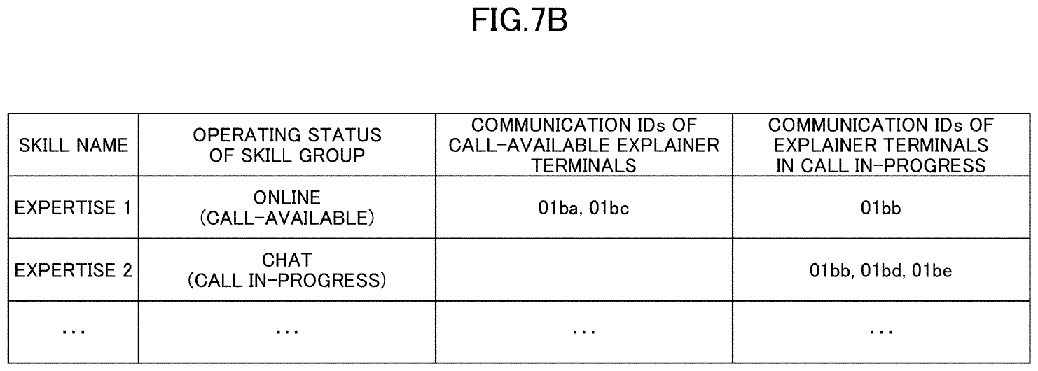

FIG. 7A is a schematic diagram illustrating an explainer management table. In the storage unit 1000, the explainer management DB 1001 configured with the explainer management table illustrated in FIG. 7A is constructed. In the explainer management table, various types of information (a communication ID, the name of the explainer, an operating status (presence) of the destination candidate, the skill name representing the skill of the explainer used in the explainer terminal, and a desired skill) of a destination candidate for the store terminal 1 (in this example, the explainer terminal 9) are managed in association with each other.

The communication ID is identification information for identifying a communication destination in the communication system. Examples of the communication ID include, but are not particularly limited to, a user ID for identifying the explainer who uses the explainer terminal 9, the communication ID for identifying the explainer terminal, and the like. The explainer name in FIG. 7A is an explainer name illustrated in FIG. 24C that will be described below. The operating status indicates an operating status of the counterpart terminal in a video call. There are three types of operating statuses: Online (call is available), Chat (call in-progress), and Offline (call is not available). The operating status is reflected in the display in FIG. 24A and FIG. 24C. Skills indicate the names of the skills possessed by the explainers, as described above. As illustrated in FIG. 7A, a single explainer may have one or more skills (expertise 1, expertise 2). The skill name is information about the explainer's attributes, and the explainer management table may also include attributes such as gender, age, the length of service, and travel history of each country. The desired skill is a skill selected by a customer at the store terminal 1. That is, the desired skill is a skill selected by a customer in FIG. 24A. The desired skill is thus one of the skills possessed by an explainer. The desired skill is registered only while a call is in progress (session is in-progress).

### (Skill Group Management Table)

FIG. 7B is a schematic diagram illustrating a skill group management table. A skill group management DB 1002 is constructed in the storage unit 1000 using a skill group management table illustrated in FIG. 7B. In the skill group management table, the skill name, the operating status (presence) of the skill group, the communication ID of the explainer terminal with which the store terminal can communicate, and the communication ID of the explainer terminal while a call is in progress are managed in association with each other.

In the skill group management table, the operating status of the skill group indicates operating statuses of explainer terminals as a whole in the explainer group having the same skill such as expertise 1. For example, if there are several explainer terminals in the same skill group, and even one of these explainer terminals is in an online status, the operating status of the expertise 1 skill group is managed as Online. In addition, even when not all the operating statuses of multiple explainer terminals are Online, and the operating status of one of these explainer terminals is Chat, the operating status of the skill group of expertise 1 is managed as Chat. Furthermore, when the operating statuses of all the explainer terminals among multiple explainer terminals are neither Online nor Chat; that is, when all the operating statuses of the explainer terminals are Offline, the operating status of the skill group of the expertise 1 is managed as Offline.

### (Functional Configuration of Store Terminal)

The following illustrates respective components of the store terminal 1. The transmitter-receiver 11 is implemented by instructions from the CPU 101 illustrated in FIG. 4, an external device connection I/F 108, and a network I/F 109. The transmitter-receiver 11 is configured to transmit and receive various data (or information) with respect to other terminals, devices, or systems through the communication network 100.

The reception unit 12 is implemented mainly by instructions from the CPU 101 illustrated in FIG. 4, a keyboard 111, and a pointing device 112 to receive various inputs from a user.

The communication controller 13 is implemented by instructions from the CPU 101 illustrated in FIG. 4. The communication controller 13 inputs image data obtained by capturing an object from an external camera connected to the external device connection I/F 108. The communication controller 13 inputs sound data obtained by collecting sound from an external microphone connected to the external device connection I/F 108. The communication controller 13 outputs image data received from a video call counterpart and the image data obtained by the store terminal 1 to the display controller 14. The communication controller 13 outputs sound data received from the video call counterpart and the sound data obtained by the store terminal 1 to an external speaker connected to the external device connection I/F 108.

The display controller 14 is implemented mainly by instructions from the CPU 101 illustrated in FIG. 4, and outputs image data to an external display connected to the display 106 or the external device connection I/F to display the image.

The determination unit 15 is implemented mainly by instructions from the CPU 101 illustrated in FIG. 4, and performs various determinations. Details of the determination will be described later.

The storing-reading processor 19 is primarily executed by instructions from the CPU 101 and the HDD controller 105 illustrated in FIG. 4, and stores various data in the storage unit 1000 and reads various data stored in the storage unit 1000.

Further, image data and sound data received when communicating with other terminals are overwritten and stored in the storage unit 1000 every time the image data and sound data are received. Of these, an image is displayed on the display 106 or on an external display according to the image data that has not been overwritten, and sound is output from an external speaker according to the sound data that has not been overwritten.

### <Administrator Terminal>

Next, a functional configuration of the administrator terminal 4 will be described with reference to FIGS. 4 and 5. As illustrated in FIG. 5, the administrator terminal 4 includes a transmitter-receiver 41, a reception unit 42, a display controller 44, and a storing-reading processor 49. The explainer terminal 9 includes a storage unit 4000 constructed by the RAM 103 and the HD 104 illustrated in FIG. 4.

Since the transmitter-receiver 41, the reception unit 42, the display controller 44, and the storing-reading processor 49 of the administrator terminal 4 have the same functions as the transmitter-receiver 11, the reception unit 12, the display controller 14, and the storing-reading processor 49 of the store terminal 1, respectively, the description thereof will not be repeated.

### <Functional Configuration of Explainer Terminal>

Next, a functional configuration of the explainer terminal 9 will be described with reference to FIGS. 4 and 5. As illustrated in FIG. 5, the explainer terminal 9 includes a transmitter-receiver 91, a reception unit 92, a communication controller 93, a display controller 94, a determination unit 95, and a storing-reading processor 99. The explainer terminal 9 includes a storage unit 9000 constructed by the RAM 103 and the HD 104 illustrated in FIG. 4. An explainer management DB 9001 and a skill group management DB 9002 are constructed in the storage unit 9000.

Since the transmitter-receiver 91 (an example of a second transmitter-receiver), the reception unit 92, the communication controller 93, the display controller 94, the determination unit 95, and the storing-reading processor 99 of the explainer terminal 9 have the same functions as the transmitter-receiver 11, the reception unit 12, the communication controller 13, the display controller 14, the determination unit 15, and the storing-reading processor 19 of the store terminal 1, respectively, these descriptions are omitted. In addition, since the explainer management DB 9001 and the skill group management DB 9002 of the explainer terminal 9 have the same data structure as those of the explainer management DB 1001 and the skill group management DB 1002 of the store terminal 1, the description thereof will not be repeated.

### <Functional Configuration of Relay Device>

Next, a functional configuration of a relay device 3 will be described with reference to FIGS. 4 and 6. As illustrated in FIG. 6, the relay device 3 includes a transmitter-receiver 31 also serving as a forwarder, a determination unit 32, and a storing-reading processor 39. Each of these components is a function or a functional unit configured to implement any one of the components illustrated in FIG. 4 by operating instructions from the CPU 101 according to a program loaded from the HD 104 to the RAM 103. The relay device 3 includes a storage unit 3000 constructed by the RAM 103 and the HD 104 illustrated in FIG. 4.

### (Functional Configuration of Relay Device)

Next, each functional configuration of the relay device 3 will be described in detail. The transmitter-receiver 31 of the relay device 3 illustrated in FIG. 6 is implemented by instructions from the CPU 101 illustrated in FIG. 4 and the network I/F 109 illustrated in FIG. 4. The transmitter-receiver 31 transmits and receives various data (or information) to or from other terminals, devices, or systems through the communication network 100. The transmitter-receiver 31 also serves as a forwarder, and transmits image data and sound data received from a predetermined terminal to another terminal.

The determination unit 32 is implemented by instructions from the CPU 101 illustrated in FIG. 4, and determines a data latency status.

The storing-reading processor 39 is implemented by instructions from the CPU 101 illustrated in FIG. 4 and the HDD controller 105 illustrated in FIG. 4. The storing-reading processor 39 stores various data in the storage unit 3000 and reads various data stored in the storage unit 3000.

### <Functional Configuration of Communication Management Device>

Next, a functional configuration of the communication management device 5 will be described with reference to FIGS. 4 and 6. As illustrated in FIG. 6, the communication management device 5 includes a transmitter-receiver 51, a selector 53, a creator 54, a determination unit 55, and a storing-reading processor 59. Each of these components is a function or a functional unit implemented by operating any of the components illustrated in FIG. 4 by instructions from the CPU 101 according to a program loaded in the RAM 103 from the HD 104. The communication management device 5 includes a storage unit 5000 constructed by the RAM 103 and the HD 104 illustrated in FIG. 4.

### (Authentication Management Table)

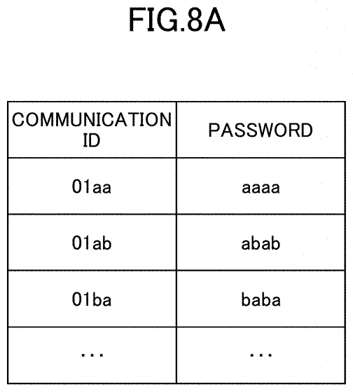

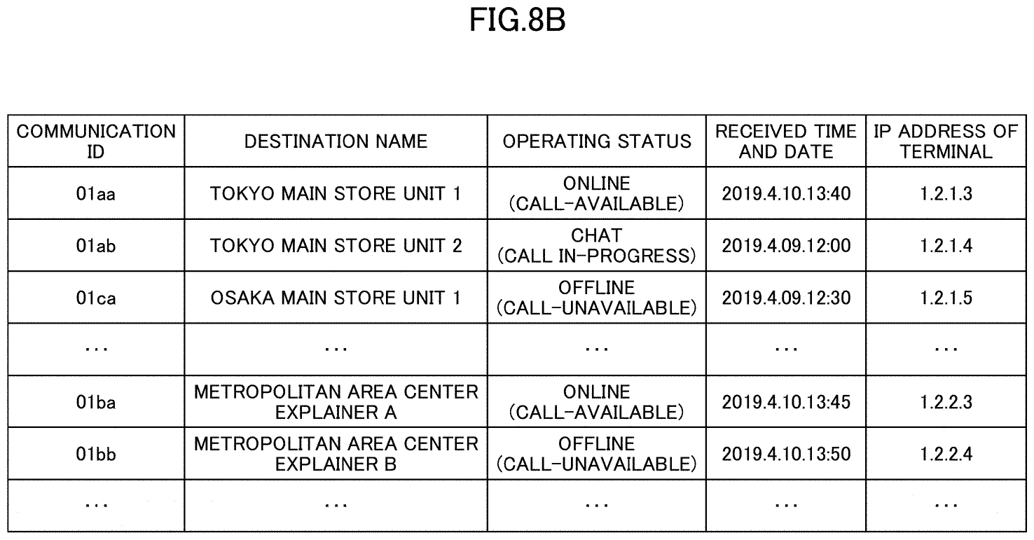

FIG. 8A is a schematic diagram illustrating an authentication management table. In the storage unit 5000, the authentication management DB 5001 configured with an authentication management table illustrated in FIG. 8A is constructed. In the authentication management table, a password is managed in association with a corresponding one of communication IDs of all the store terminals 1 and the explainer terminals 9 managed by the communication management device 5. The password is an example of authentication information, and the authentication information includes an access token.

### (Terminal Status Management Table)

FIG. 8B is a schematic diagram illustrating a terminal status management table. In the storage unit 5000, the terminal status management DB 5002 configured with a terminal status management table illustrated in FIG. 8B is constructed. In this terminal status management table, respective communication IDs of the store terminal 1 and the explainer terminal 9 are managed in association with destination names of the store terminal 1 and the explainer terminal 9 acting as destinations, and operating statuses of the store terminal 1 and the explainer terminal 9, time and date when login request information has been received by the communication management device 5, and IP addresses of the store terminal 1 and the explainer terminal 9. Note that the communication ID, the destination name, and the IP address of the terminal are stored when the store terminal 1 and the explainer terminal 9 are registered in advance to receive service provided by the communication management device 5.

### (Destination List Management Table)

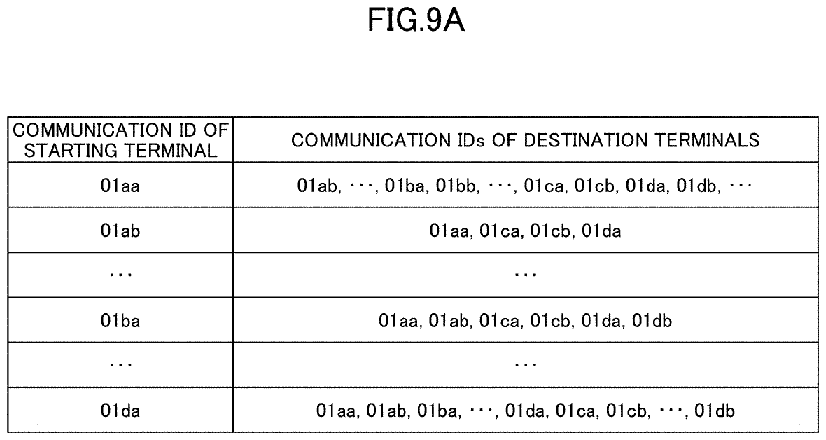

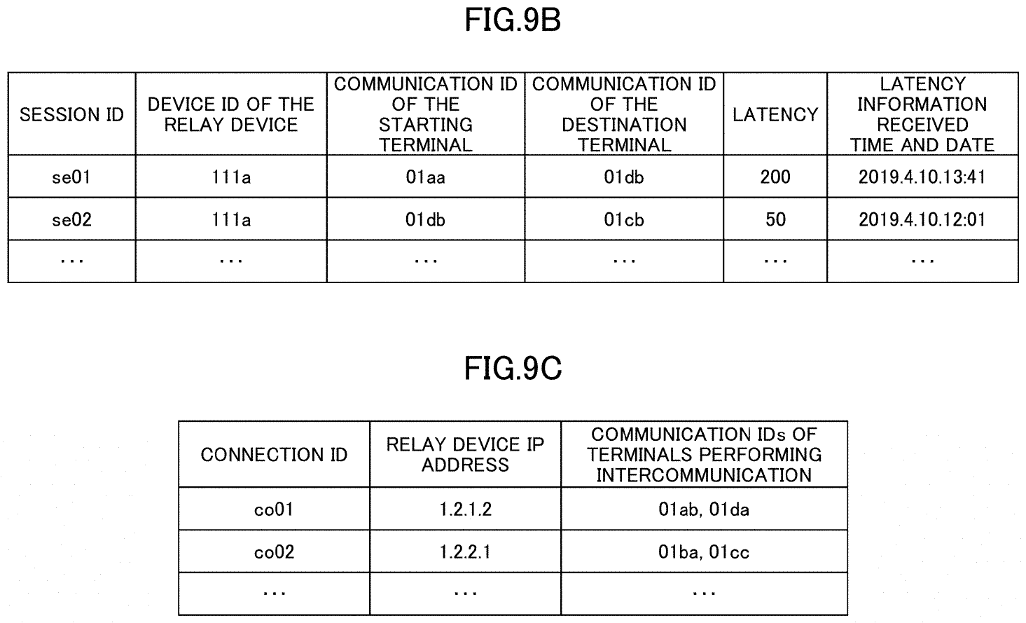

FIG. 9A is a schematic diagram illustrating a destination list management table. The destination list management DB 5003 configured with a destination list management table illustrated in FIG. 9A is constructed in the storage unit 5000. In this destination list management table, communication IDs of the destination terminals registered as candidates for the destination terminal are managed in association with the communication ID of the start terminal requesting the start of the call. The candidates for the destination terminal are updated by being added or deleted by the request for addition or deletion from the administrator terminal 4 to the communication management device 5.

The destination list is an example of destination information. The destination information may not necessarily be in a list format, and may be series of destination information, such as the communication IDs.

### (Session Management Table)

FIG. 9B is a schematic diagram illustrating a session management table. In the storage unit 5000, the session management DB 5004 configured with a session management table illustrated in FIG. 9B is constructed. In the session management table, each communication session ID for identifying an intercommunication session between each terminal and the relay device 3 is managed in association with a relay device ID of the relay device 3 used, a communication ID of the start terminal, a communication ID of the destination terminal, received latency (ms) upon image data being received at the destination terminal, and received time and date at which latency information indicating the latency transmitted from the destination terminal is received by the communication management device 5.

### (Communication Information Management Table)

FIG. 9C is a schematic diagram illustrating a communication information management table. A communication information management DB 5005 configured with a communication information management table illustrated in FIG. 9C is constructed in the storage unit 5000. In this communication information management table, a connection ID for identifying the intercommunication performed between each terminal and the relay device 3 is managed in association with an IP address of the relay devices 3 used for connection, and communication IDs of terminals performing intercommunication via the relay device. The connection ID may also be referred to as a conference ID, which serves as information for causing the relay device 3 to perform intercommunication of videos and audio between communication terminals joining the same conference.

### (Functional Configuration of Communication Management Device)

Next, a functional configuration of the communication management device 5 will be described in detail. In describing each functional configuration of the communication management device 5, a relationship with the main components, from among the components illustrated in FIG. 4, for implementing the functional configuration of the communication management device 5 will also be described.

The transmitter-receiver 51 of the communication management device 5 illustrated in FIG. 6 is implemented by instructions from the CPU 101 and the network I/F 109 illustrated in FIG. 4. The transmitter-receiver 51 transmits and receives various data (or information) to or from other terminals, devices, or systems through the communication network 100 (an example of the first transmitter-receiver).

The selector 53 is implemented by instructions from the CPU 101 illustrated in FIG. 4, and selects the optimal relay device 3 for intercommunication based on the IP address of each terminal.

The creator 54 is implemented by instructions from the CPU 101 illustrated in FIG. 4, and creates communication information in response to a request for starting intercommunication from each terminal. The communication information includes the IP address of the relay device selected by the selector 53 and the above described communication IDs.

The determination unit 55 is implemented by instructions from the CPU 101 illustrated in FIG. 4, and performs various determinations.

The storing-reading processor 59 is implemented by instructions from the CPU 101 and the HDD controller 105 illustrated in FIG. 4, and stores various data in the storage unit 5000 and reads various data stored in the storage unit 5000.

### <Service Information Management Device>

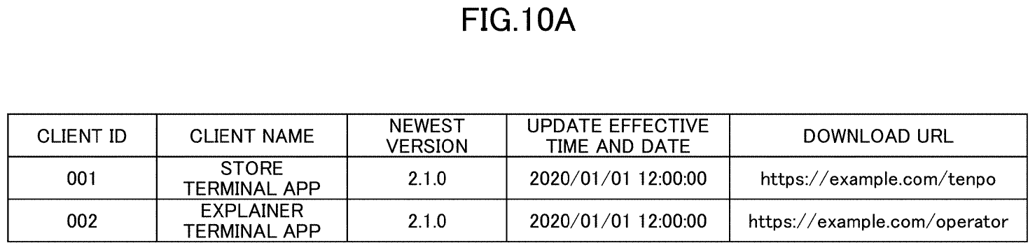

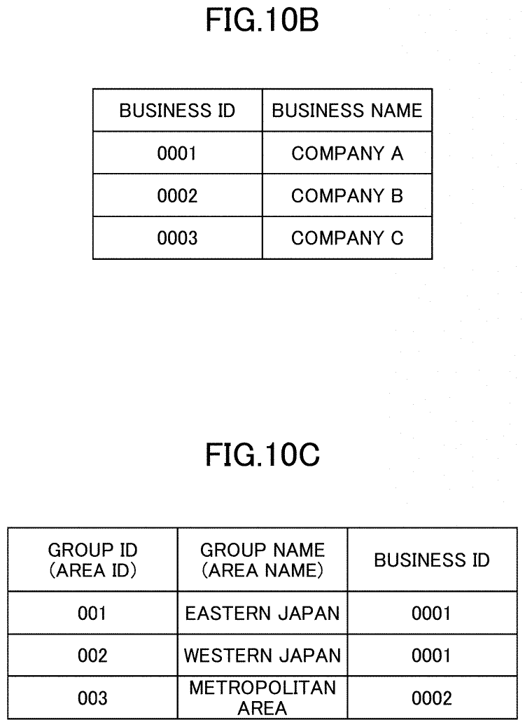

Next, a functional configuration of the service information management device 7 will be described with reference to FIGS. 4 and 6. As illustrated in FIG. 6, the service information management device 7 includes a transmitter-receiver 71, a determination unit 75, and a storing-reading processor 79. Each of these components is a function or a functional unit implemented by operating any of the components illustrated in FIG. 4 by instructions from the CPU 101 according to a program loaded in the RAM 103 from the HD 104. The service information management device 7 includes a storage unit 7000 constructed by the RAM 103 and the HD 104 illustrated in FIG. 4. The service information management DB 7001 is constructed in the storage unit 7000. Each table illustrated in FIGS. 10A to 12C is constructed in the service information management DB 7001.

### (System Update Information Management Table)

FIG. 10A is a schematic diagram illustrating a system update information management table. In this system update information management table, each client ID is managed in association with a client name, a latest version, an update effective time and date, and a download URL (Uniform Resource Locator). In the client name field, a store terminal application indicates an application for the store terminal 1, and an explainer terminal application indicates an application for the explainer terminal 9. Each application is managed by a corresponding download URL. The function of the application for the store terminal 1 differs from the function of the application for the explainer terminal 9. The application for the store terminal 1 can only adjust the volume of the counterpart. The application for the explainer terminal 9 can also be operated by the application of the store terminal so that the customer does not have to operate the application.

### (Business Management Table)

FIG. 10B is a schematic diagram illustrating a business management table. In this business management table, respective business IDs are managed in association with business names. The businesses are, for example, a travel agency, a leasing company, and the like.

### (Group Management Table)

FIG. 10C is a schematic diagram illustrating a group management table. In this group management table, group names (area names) are managed in association with the business IDs on a per group ID (area ID) basis. The group indicates the area E1 or the like in FIG. 2.

### (Terminal Management Table)

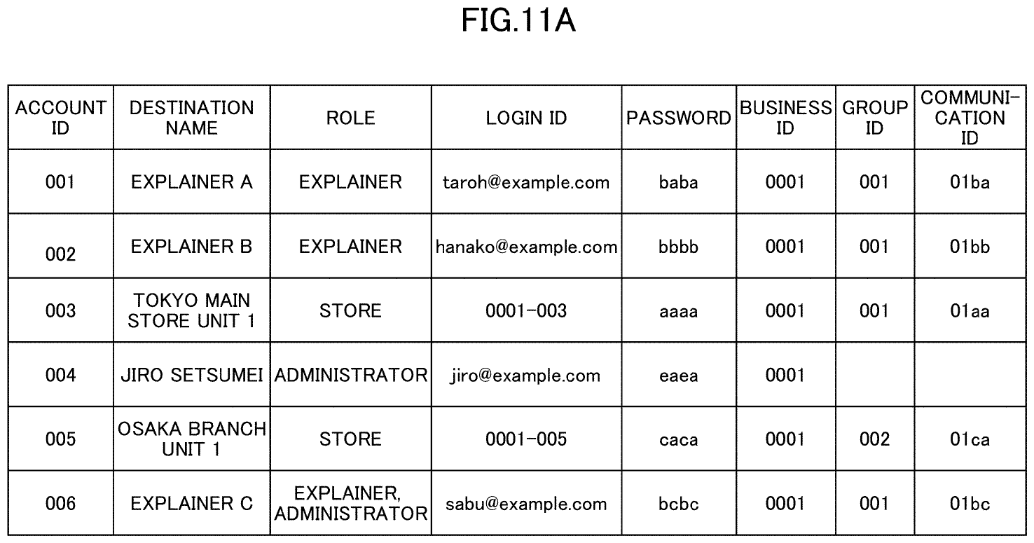

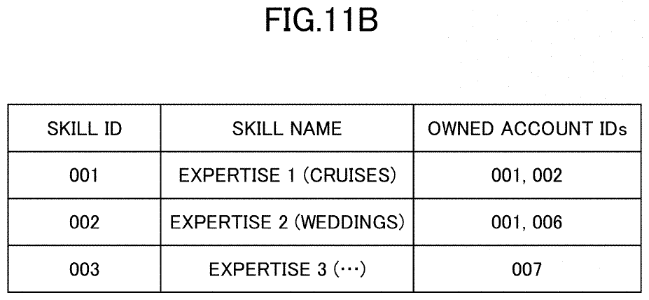

FIG. 11A is a schematic diagram illustrating a terminal management table. In this terminal management table, each account ID is managed in association with a destination name, a role, a login ID, a password, a business ID, a group ID, and a communication ID. The account ID is identification information to identify a store, an explainer, and an administrator. In the case of a store, an account of the store itself, not the customer, is managed. The destination name is also managed in the terminal status management table illustrated in FIG. 8B, but as illustrated in FIG. 24C, the destination name is a display name on the destination selection screen displayed on the store terminal 1. A role indicates a role of the administrator, a user, or the like, of the terminal. The login ID and password are used to authenticate when the administrator ad1 accesses the service information management device 7 from the administrator terminal 4. The “password” of the terminal management table is the same as the “password” of the authentication management table in FIG. 8A; however, a different password may be used. The communication ID is also managed in the terminal status management table (see FIG. 8B) of the communication management device 5.

### (Skill Management Table)

FIG. 11B is a schematic diagram illustrating a skill management table. In this skill management table, each skill ID is managed in association with a skill name and an account ID of the explainer who holds a skill. As illustrated in FIG. 11B, a plurality of skills such as expertise 1 and expertise 2 possessed by the same explainer (001) may also be managed.

### (Login Information Management Table)

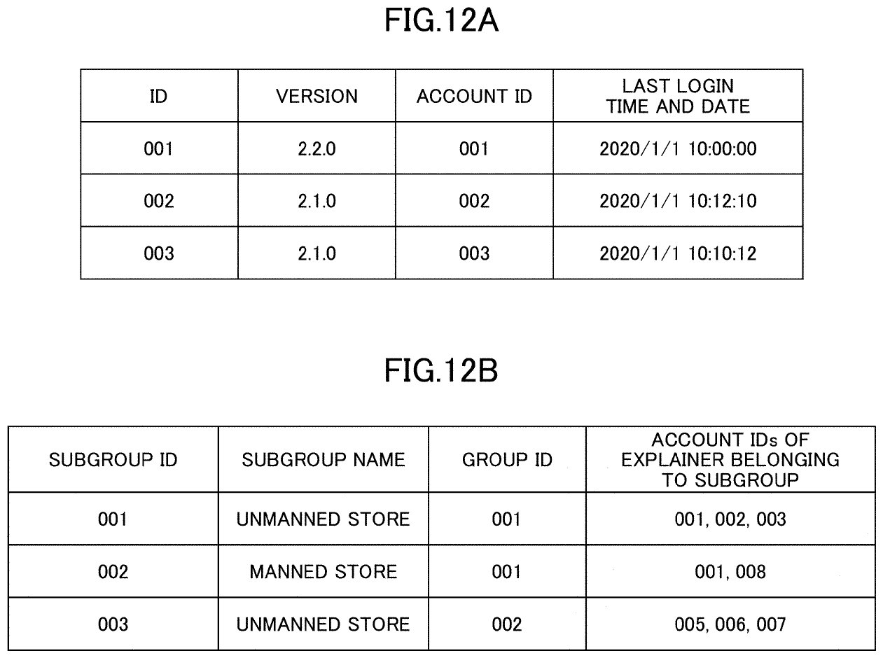

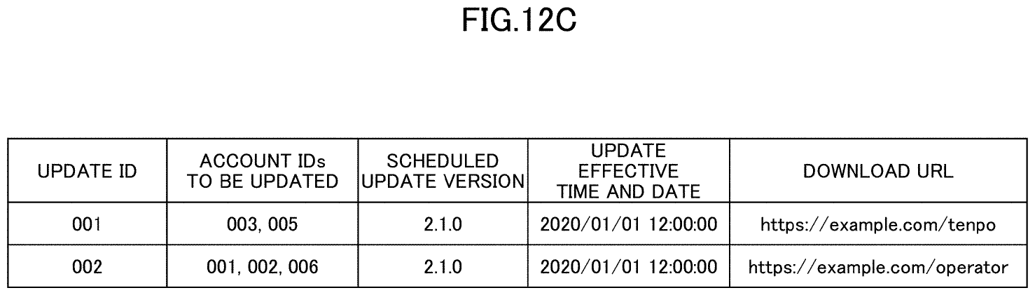

FIG. 12A is a schematic diagram illustrating a login information management table. In this login information management table, each reference number ID is managed in association with a version, an account ID, and a last login time and date. The version indicates what is the login information.

### (Subgroup Management Table)

FIG. 12B is a schematic diagram illustrating a subgroup management table. In this subgroup management table, each subgroup ID is managed in association with a subgroup name, a group ID, and account IDs of explainers who belong to the subgroup. As illustrated in FIG. 11B, a plurality of skills such as expertise 1 and expertise 2 possessed by the same explainer (001) may also be managed. In the case of the account ID of the store terminal, as illustrated in FIG. 2, the subgroup represents a manned store or an unmanned store. In the case of the account ID of the explainer, the subgroup indicates a manned store priority support organization or an unmanned store priority support organization.

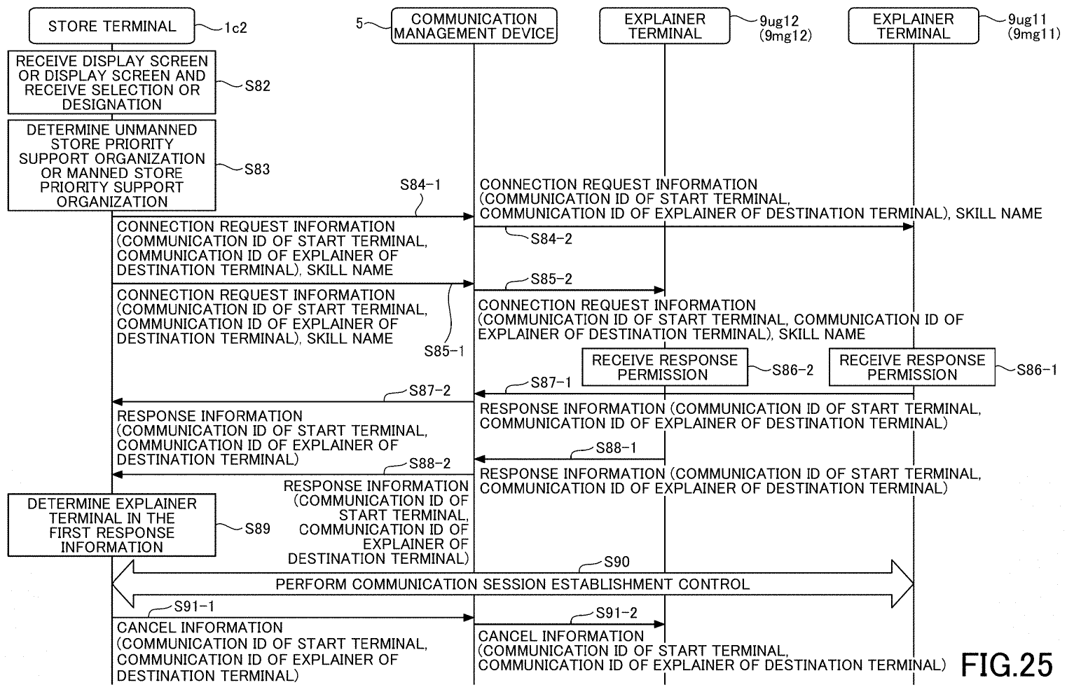

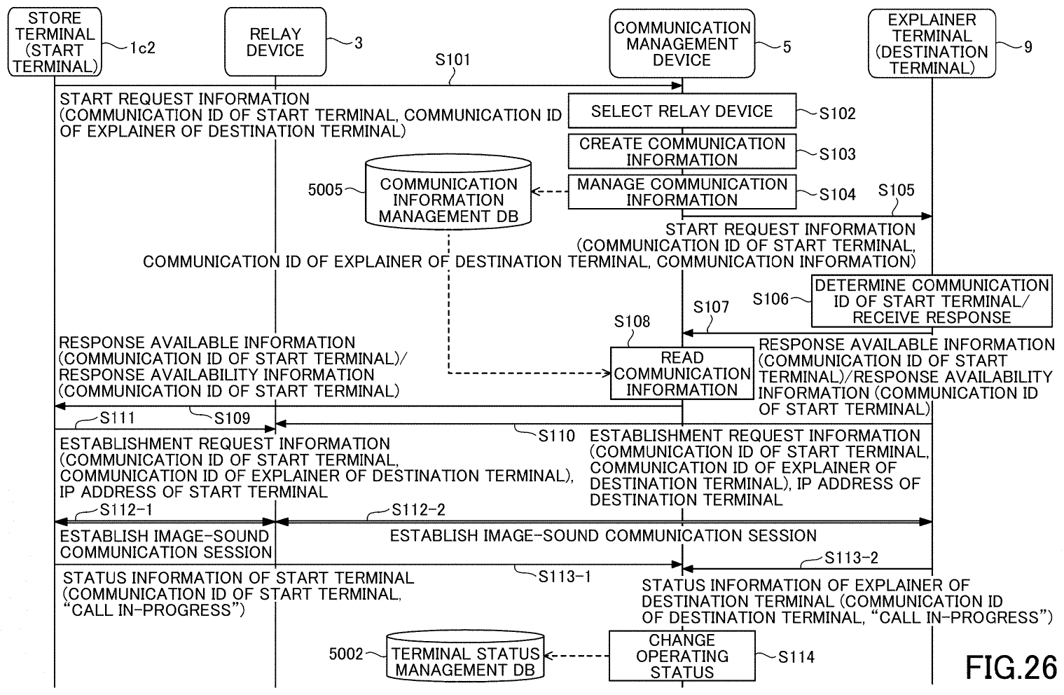

According to the subgroup management table, the store terminal with the account ID “003” (Tokyo Main store Unit 1) preferentially requests, as a preliminary step to a video call start request (see S101 in FIG. 26), the explainer terminals used by the explainers with the account IDs “002” and “003” to transmit connection request information indicating a communication session connection request for a video call all at once (first transmission) to start a video call (See S84-1 and S85-1 in FIG. 25 described later). If no response is received from the explainer terminals of the account ID “002” and “003” within a predetermined time, a call start request is transmitted (the second transmission) to predetermined explainer terminals that are online (call-available) all at once among the explainer terminals having the same skill other than those with the account ID “002” and “003”.

### (User Update Information Management Table)

FIG. 12C is a schematic diagram illustrating a user update information management table. In this user update information management table, each update ID is managed in association with an account ID to be updated, a scheduled update version, update effective time and date, and a download URL.

### (Functional Configuration of the Service Information Management Device)

Next, a functional configuration of the service information management device 7 will be described in detail. Hereinafter, in describing the functional configuration of the service information management device 7, among the components illustrated in FIG. 4, those having a relationship with the main components for implementing respective functional components of the service information management device 7 will also be described.

The transmitter-receiver 71 of the service information management device 7 illustrated in FIG. 6 is implemented by instructions from the CPU 101 and the network I/F 109 illustrated in FIG. 4, and transmits and receives various data (or information) to or from other terminals, devices, or systems through the communication network 100.

The determination unit 75 is implemented by instructions from the CPU 101 illustrated in FIG. 4, and performs various determinations.

The storing-reading processor 79 is implemented by instructions from the CPU 101 and the HDD controller 105 illustrated in FIG. 4, and performs processing for storing various data in the storage unit 7000 and a process of reading various data stored in the storage unit 7000.

### [Process or Operation of Embodiments]

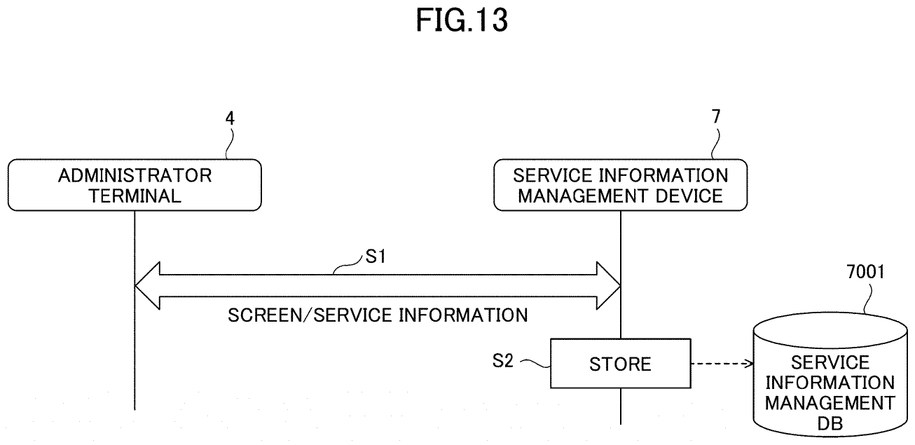

Next, a process or operation in the communication system according to the present embodiment will be described with reference to FIGS. 13 to 26. Hereinafter, the store terminal 1 as a request source for requesting the start of a video call may be represented as a “start terminal”, and the explainer terminal 9 as a request destination (relay destination) may be represented as a “destination terminal”.

### <Registration of Service Information>

First, a process to register various service information from the administrator terminal 4 to the service information management device 7 will be described with reference to FIGS. 13 to 20. The service information is managed in each table in FIGS. 10A to 12C.

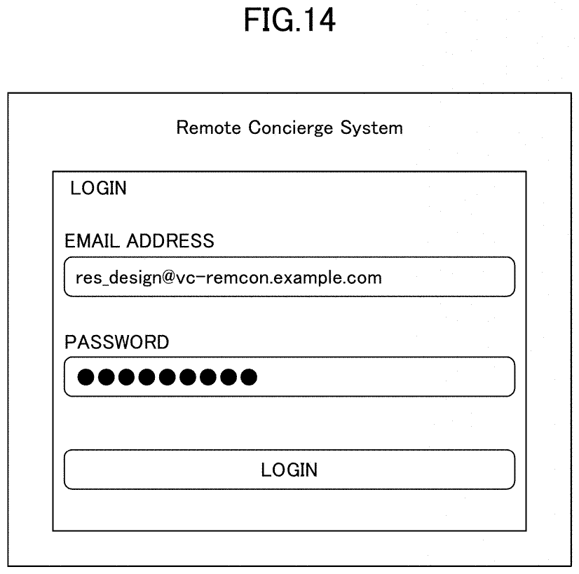

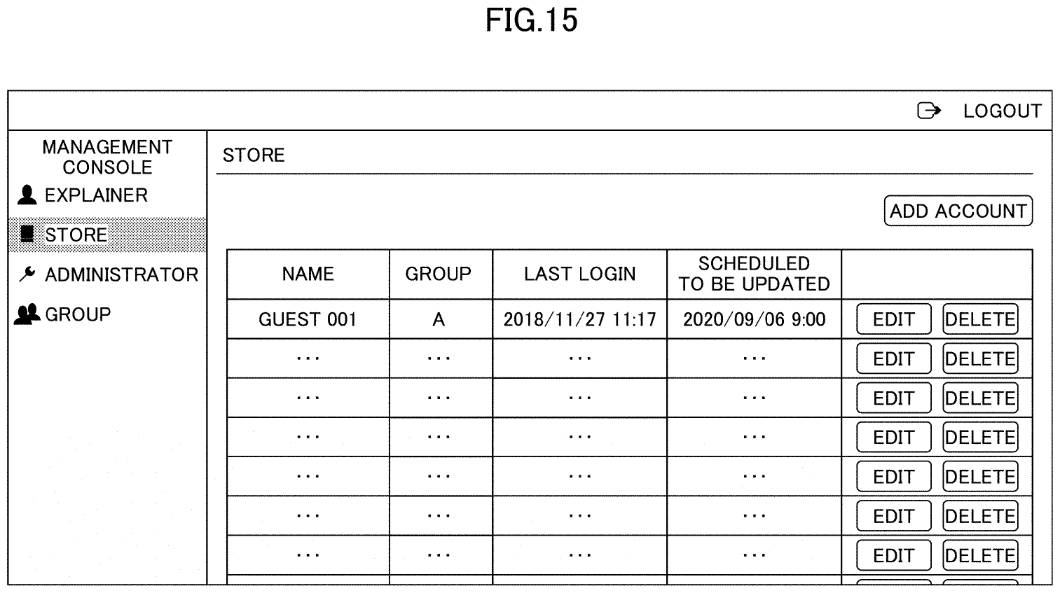

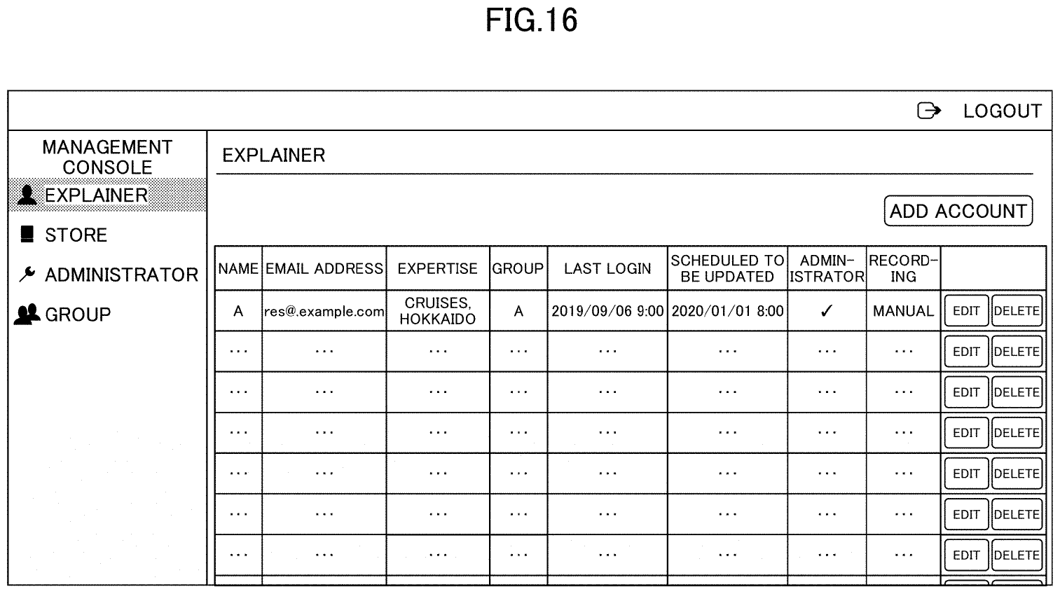

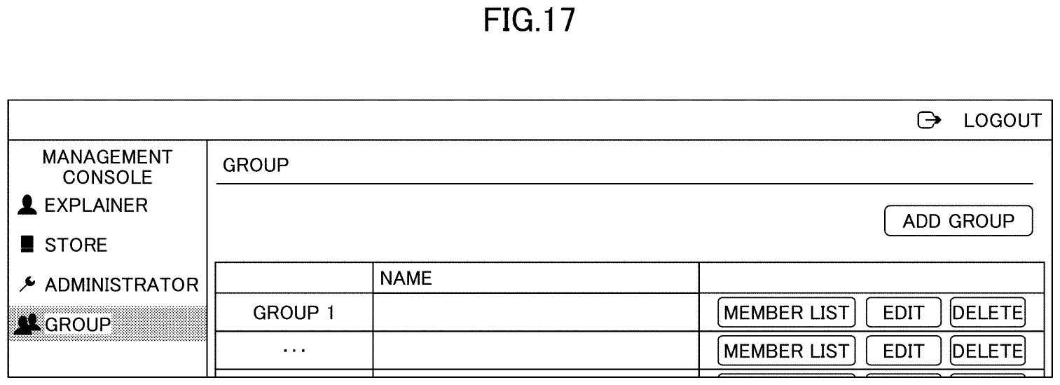

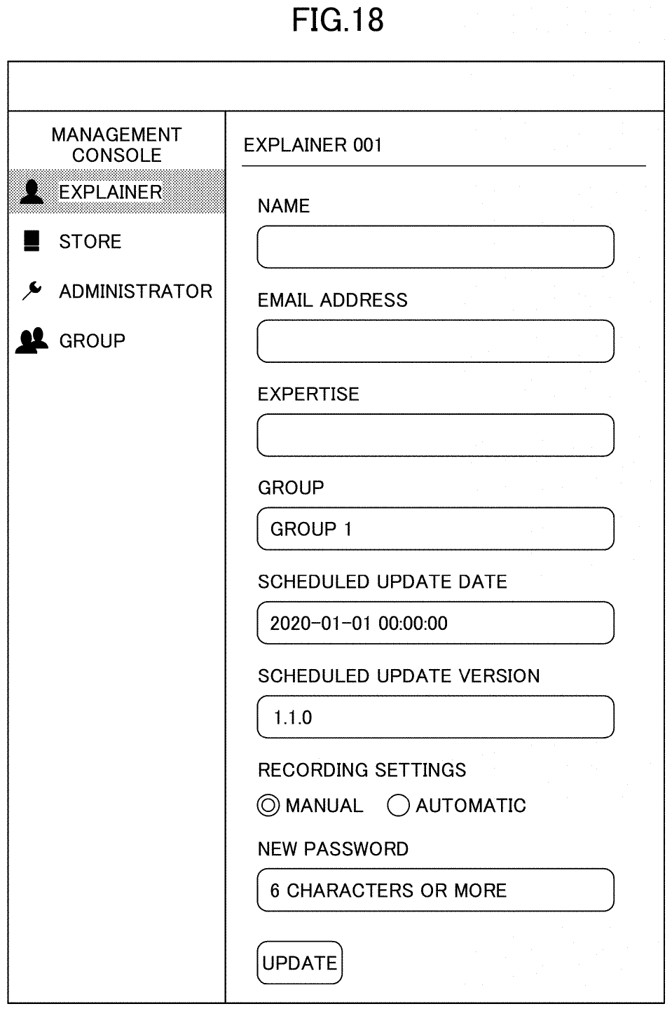

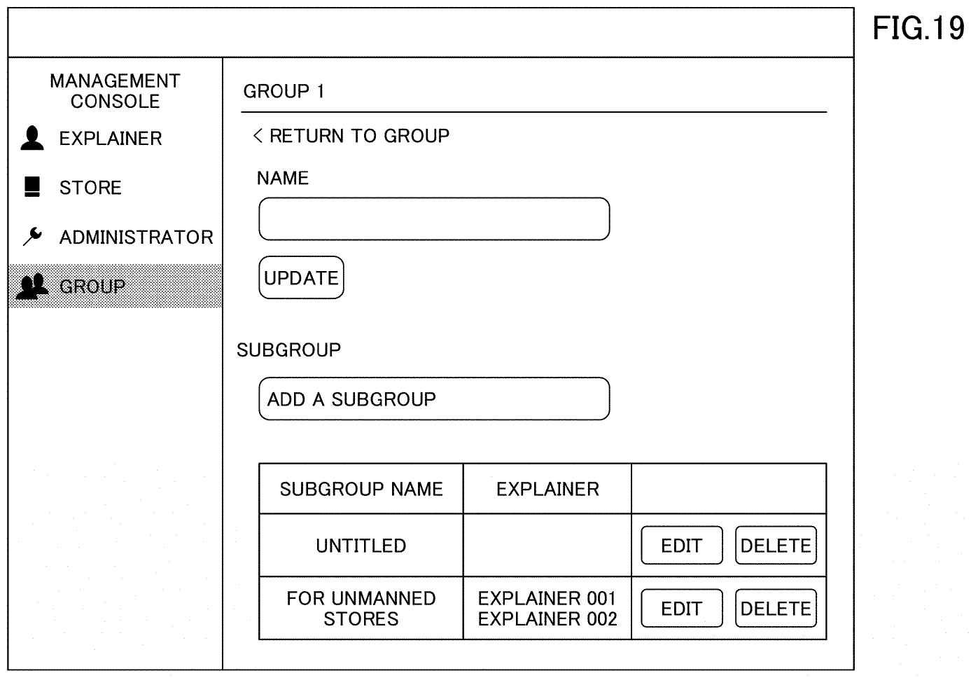

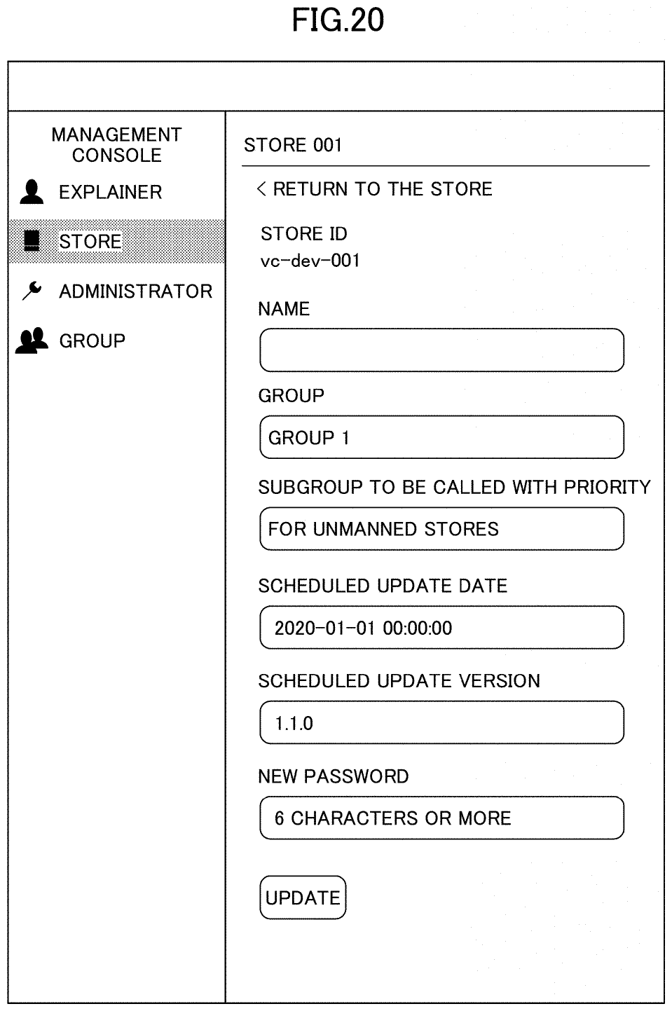

FIG. 13 is a sequence diagram illustrating a process of registering service information. FIG. 14 is a diagram illustrating a login screen displayed by an administrator terminal. FIG. 15 is a diagram illustrating a store list screen displayed on the administrator terminal. FIG. 16 is a diagram illustrating an explainer list screen displayed on the administrator terminal. FIG. 17 is a diagram illustrating a group list screen displayed on the administrator terminal. FIG. 18 is a diagram illustrating an explainer information editing screen displayed on the administrator terminal. FIG. 19 is a diagram illustrating a group information editing screen displayed on the administrator terminal. FIG. 20 is a diagram illustrating a store information editing screen displayed on the administrator terminal.

As illustrated in FIG. 13, an administrator ad1 uses an administrator terminal 4 to access the service information management device 7 through the communication network 100. The web browser (a display controller 44) of the administrator terminal 4 displays screens in FIGS. 14 to 20 on the display 106, and a transmitter-receiver 41 transmits each service information input or selected by the administrator ad1 via the screens to the service information management device 7 (S1). In the service information management device 7, the transmitter-receiver 71 receives each service information, and the storing-reading processor 79 stores received service information in the service information management DB 7001. Thus, the service information is managed in each table illustrated in FIGS. 10A to 12C.

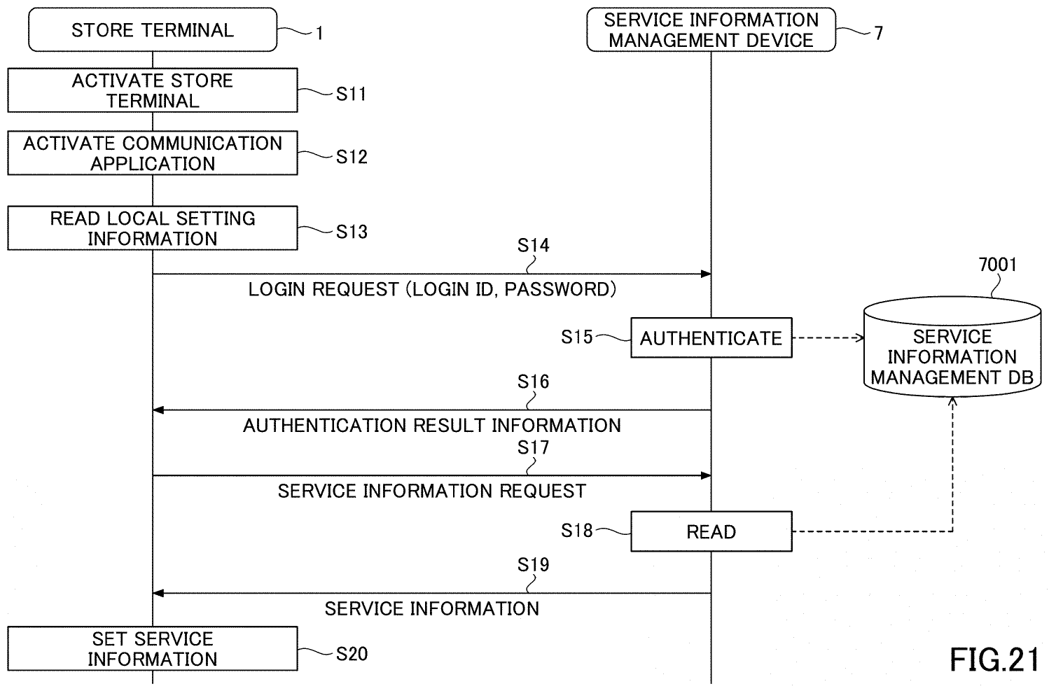

The screens are displayed in the order in FIGS. 14 through 20. For example, in the group information editing screen illustrated in FIG. 19, the administrator ad1 inputs an account ID of an explainer of the explainer terminal 9 who desires to transmit a call start request with priority in the “explainer” field of the subgroup (for unmanned store). Further, in the store information editing screen illustrated in FIG. 20, the administrator ad1 inputs a subgroup name (here, for an unmanned store) in the “subgroup to be called with priority” field. Accordingly, the store terminal 1 acquires the service information from the service information management device 7 (see S19 in FIG. 21 below) and manages the explainer terminal 9 to which the store terminal 1 should preferentially transmit the call start request (see S20).

### <Video Call Preparation Process>

Next, a video call preparation process for a remote customer will be described with reference to FIGS. 21 to 24. FIG. 21 is a sequence diagram illustrating a call preparation process of a store terminal.

First, when a customer who has come to a store turns on the power switch of a store terminal 1, a reception unit 12 receives the power ON to activate the store terminal 1 (S11). When the store terminal 1 is activated, a communication application installed in the store terminal 1 is activated (S12). Hereinafter, a process in the store terminal 1 is executed by instructions of the communication application. The storing-reading processor 19 then reads local setting information from the storage unit 1000 (S13). Accordingly, the store terminal 1 completes the setting of a background image of a display screen, the preparation of a login ID and a password, and the like.

Next, the transmitter-receiver 11 of the store terminal 1 transmits a login request to the service information management device 7 through the communication network 100 (S14). This login request includes a login ID and a password read in step S13. Thus, the transmitter-receiver 71 of the service information management device 7 receives the login request. When the login request is transmitted from the store terminal 1 to the service information management device 7, the receiving side service information management device 7 can acquire the IP address of the transmitting side store terminal 1.

Next, the determination unit 75 of the service information management device 7 searches the terminal management table (FIG. 11(A)) of the service information management DB 7001 using the login ID and the password included in the login request as a search key and performs authentication by determining whether the same login ID and password are managed in the terminal management table (S15).

The transmitter-receiver 71 of the service information management device 7 transmits authentication result information representing the authentication result to the store terminal 1 (S16). Accordingly, the transmitter-receiver 11 of the store terminal 1 receives the authentication result information.

Next, the transmitter-receiver 11 of the store terminal 1 transmits a service information request to the service information management device 7 (S17). Accordingly, the transmitter-receiver 71 of the service information management device 7 receives the service information request.

Next, in the service information management device 7, the storing-reading processor 79 reads service information from the service information management DB 7001 (S18). The transmitter-receiver 71 transmits service information to the store terminal 1 (S19). As a result, the transmitter-receiver 11 of the store terminal 1 receives the service information. Next, in the store terminal 1, the storing-reading processor 19 sets the service information (S20).

### <Start Process of Video Call>

First, the creator 54 of the store terminal 1 creates a session ID for independently identifying a communication session by itself in S22. Next, the transmitter-receiver 11 transmits login request information representing a login request to the communication management device 5 through the communication network 100 (S23). The login request information includes the session ID created in step S22, and the communication ID and password of the store terminal 1 in the service information acquired in step S19. Here, the communication ID is the start terminal ID for identifying the store terminal 1 that has transmitted the login request in step S23.

Next, the storing-reading processor 59 of the communication management device 5 searches the authentication management table (see FIG. 8A) using the communication ID and the password included in the login request information received through the transmitter-receiver 51 as a search key, and performs terminal authentication by determining whether the same communication ID and the same password are managed in the authentication management table (S24). The following is described on the basis of the assumption in which the storing-reading processor 59 has authenticated that the same communication ID and the same password are managed in the authentication management table.

When the storing-reading processor 59 determines that the same communication ID and the same password are managed in the authentication management table so as to determine that the login request is from a terminal having a legitimate access right, the storing-reading processor 59 changes an operating status field portion of the record associated with the communication ID received in step S23 to “Online (call-available)”, and stores the received time and date upon the login request being received in step S23 in the received time and date field portion (S25). As a result, in the terminal status management table, for example, the communication ID “01aa” is managed in association with the operating status “Online (call-available)”, the received time and date “2019.4.10.13:40”, and the IP address “1.2.1.4”. Note that the IP address of the terminal may not be registered in advance, but instead may be transmitted from the store terminal 1 in step S23.

Next, the storing-reading processor 59 additionally manages a new record including the communication ID and the password of the store terminal 1 received in the above-described step S23 in the session management table (see FIG. 9B) (S26). The transmitter-receiver 51 of the communication management device 5 transmits authentication result information indicating the authentication result obtained in the above-described step 24 to the store terminal 1 that has requested login through the communication network 100 (S27).

When the transmitter-receiver 11 of the login request terminal (the store terminal 1) receives authentication result information indicating that the store terminal 1 has the legitimate access right, the transmitter-receiver 11 transmits destination list request information indicating that the destination list has been requested to the communication management device 5 through the communication network 100 (S28). Thus, the transmitter-receiver 51 of the communication management device 5 receives the destination list request information.

Next, the storing-reading processor 59 searches the destination list management table (see FIG. 9A) using the communication ID “01ab” of the login request terminal (the store terminal 1) as a search key, reads the communication IDs of the destination candidates capable of communicating with the login request terminal (the store terminal 1), and reads destination names associated with the communication IDs from the terminal status management table (see FIG. 8B) (step S29). In this case, the communication IDs of the destination candidates associated with the communication ID “01ab” of the login request terminal (the store terminal 1) and the destination names corresponding the communication IDs of the destination candidates are extracted.

Next, the storing-reading processor 59 of the communication management device 5 reads destination list frame data from the storage unit 5000 (S30). The transmitter-receiver 51 transmits “destination list information (destination list frame, communication ID, and destination name) including the destination list frame, and the communication ID and the destination name read by the storing-reading processor 59 to the login request terminal (the store terminal 1) (S31). Accordingly, in the login request terminal (the store terminal 1), the transmitter-receiver 11 receives the destination list information, and the storing-reading processor 19 stores the destination list information in the storage unit 1000 (S32).

As described above, in the present embodiment, the destination list information is not managed by each terminal; but the communication management device 5 centrally manages the destination list information of all terminals. As such, the communication management device 5 can collectively handle changes to the destination list information even when a new terminal is included in the communication system, a new terminal is included instead of a terminal already included, or the appearance of the destination list frame is changed, thereby eliminating a burden of changing the destination list information on each terminal side.

The storing-reading processor 59 of the communication management device 5 searches the terminal status management table (see FIG. 8B) using the communication IDs of the read destination candidates as search keys, and reads the corresponding operating statuses on a per communication ID basis, thereby acquiring operating statuses of respective communication terminals as the destination candidates (S33).

Next, the transmitter-receiver 51 transmits “terminal status information” including each communication IDs as a search key used in step S26, and the operating status of the corresponding destination terminal to the start terminal (the store terminal 1) via the communication network 100 (S34).

Next, the storing-reading processor 19 of the start terminal (the store terminal 1) sequentially stores status information of each explainer terminal 9 received from the communication management device 5 in the storage unit 1000 (S35). Thus, since the start terminal (the store terminal 1) receives status information of each of the explainer terminals 9, the start terminal (the store terminal 1) can acquire the current operating statuses of the explainer terminals 9 the like, acting as the destination candidates capable of communicating with the start terminal (the store terminal 1).

Next, the display controller 14 of the login request terminal (the store terminal 1) creates a destination list that reflects statuses of the terminals acting as destination candidates, based on the destination list information and the terminal status information stored in the storage unit 1000 (S36). The destination list is displayed on the store terminal 1 as illustrated later in FIG. 24C.

Meanwhile, the storing-reading processor 59 of the communication management device 5 searches the destination list management table (see FIG. 9A) based on the communication ID of the login request terminal (the store terminal 1) and extracts communication IDs of other terminals that have registered the communication ID of the login request terminal (store terminal 1) as a destination candidate (S37).

Next, the storing-reading processor 59 of the communication management device 5 searches the terminal status management table (see FIG. 8B) based on the communication ID of the login request terminal (the store terminal 1) and acquires the operating status of the login request terminal (the store terminal 1) (S38).

From among the terminals associated with the communication IDs extracted in step S37, the transmitter-receiver 51 transmits “terminal status information” including the communication ID and the operating status of the login request terminal (the store terminal 1) acquired in step S38 to the terminals whose operating status is “Online” in the terminal status management table (see FIG. 8B) (S39). When the transmitter-receiver 51 transmits terminal status information to the explainer terminal 9, the transmitter-receiver 51 refers to IP addresses of the communication terminals managed in the terminal status management table (see FIG. 8B) based on the respective communication IDs. Thus, the transmitter-receiver 51 transmit can transmit the communication ID and the operating status of the login request terminal (the store terminal 1) to each of other destination terminals capable of communicating with the login request terminal (the store terminal 1) as the destination candidate. As a result, the statuses of the destination candidates can be displayed on the destination candidate (the explainer terminal 9), as illustrated in FIG. 24C (S40).

### <Determination of Operating Status of Explainer Terminal>

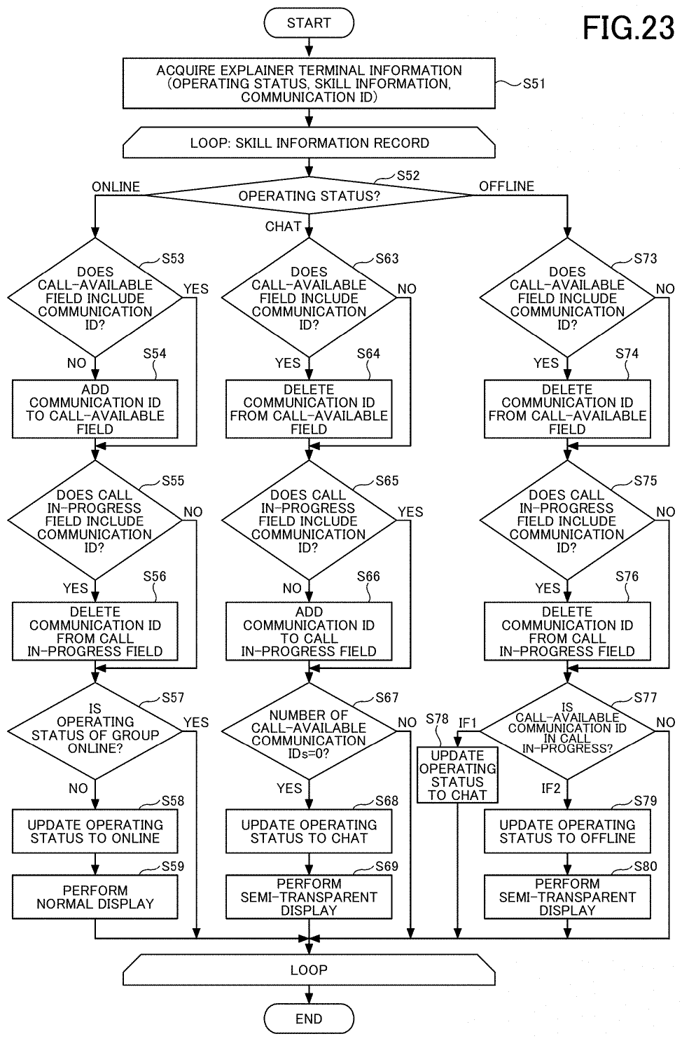

Next, a process in which the store terminal 1 determines the operating status of the explainer terminal group on a per skill basis will be described with reference to FIG. 23. FIG. 23 is a flowchart illustrating a process of preparing for a video call of a store terminal, and particularly illustrating a process of determining an operating status of explainer terminal group on a per skill basis. The operating status “Online” of the skill group indicates that the operating status of at least one of the communication-available destination candidates in this skill group is “Online”. The operating status “Chat” of the skill group indicates that none of the destination candidates in this skill group is in the “Online” status, and at least one destination candidate in this skill group is in the “Chat” status. Further, the operating status “Offline” of the skill group indicates that any of the candidate destinations in this skill group is in the “Offline” status. Hereinafter, an example of a process of determining the operating status of a skill group will be described.

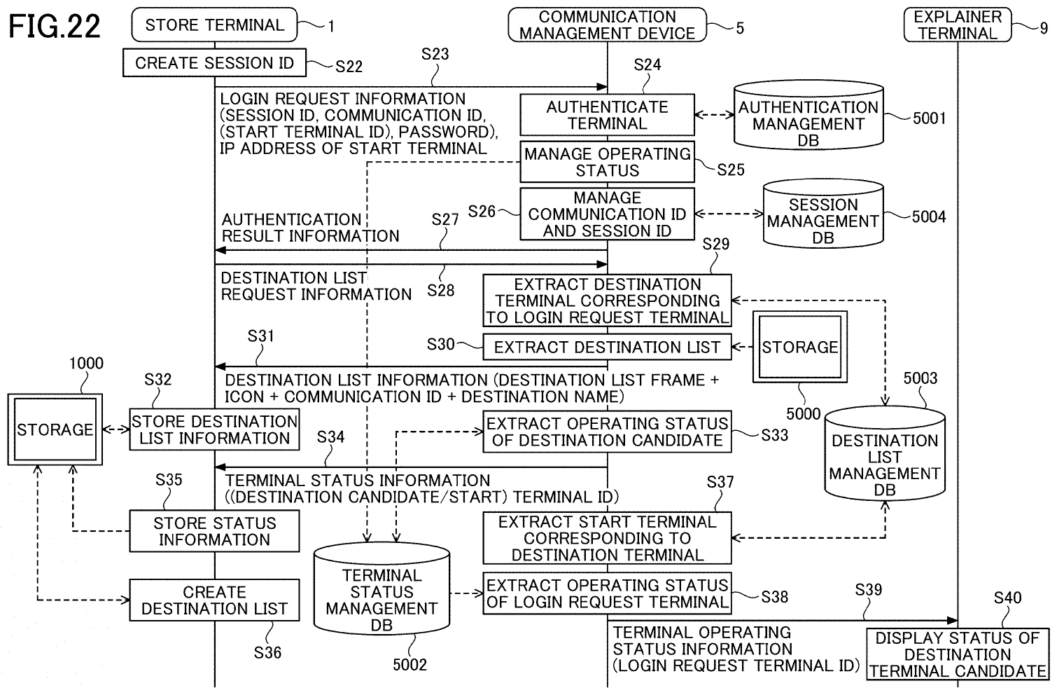

The storing-reading processor 19 of the store terminal 1 acquires information recorded in an updated record every time the operating status of the destination management table is updated in step S34 in FIG. 22 (S51). The information to be acquired includes a communication ID of the explainer terminal 9ug11, an operating status indicating a current status of the explainer terminal 9ug11 serving as a destination candidate, and a skill name indicating the skill of the explainer using the explainer terminal 9ug11 serving as a destination candidate.

The storing-reading processor 19 of the store terminal 1 updates each of the records including the skill name acquired in step S51 in the skill group management DB 1002. That is, when the acquired skill names are “Expertise 1, Expertise 2”, the storing-reading processor 19 updates each of the records that includes the skill names “Expertise 1, Expertise 2” in the skill group management DB 1002.

Hereinafter, as an example, a process when the operating status information (the operating status “Online”, the skill name (expertise 1, expertise 2), and the communication ID “01ba” are transmitted from the explainer terminal 9ug11 to the store terminal 1, and these pieces of information are acquired in step S51 will be described (S52: Online).

First, in the loop process, a process of updating a record having the skill name “Expertise 1” in the table of the skill group management DB 1002 will be described. The storing-reading processor 19 of the store terminal 1 refers to a call-available field of the communication ID in the record having the skill name “Expertise 1” in the skill group management DB 1002 (see FIG. 7B). Accordingly, the determination unit 15 determines whether the communication ID “01ba” acquired in step S51 is included in the call-available field (S53).

When the determination unit 15 determines that the communication ID “01ba” acquired in step S51 is not included in the call-available field in the skill group management DB 1002 (S53: NO), the storing-reading processor 19 adds the acquired communication ID “01ba” to the call-available field (S54).

When step S54 is completed, or when YES is applied in step S53, the storing-reading processor 19 of the store terminal 1 refers to call in-progress field in the record having the skill name “Expertise 1” in the skill group management DB 1002 (see FIG. 7B). Accordingly, the storing-reading processor 19 determines whether the communication ID “01ba” acquired in step S51 is included in the call in-progress field (S55).

When the determination unit 15 determines that the communication ID “01ba” acquired in step S51 is included in the call in-progress field in the skill group management DB 1002 (S55: YES), the acquired communication ID is deleted from the call in-progress field (S56). As a result of the process up to this point, regardless of whether the operating status of the explainer terminal 9ug11 side is changed from “Chat” to “Online” or from “Offline” to “Online”, the communication ID of the explainer terminal 9ug11 is recorded only in the call-available field in the record having the skill name “Expertise 1” in the skill group management DB 1002.

When step S56 is completed or when the determination of NO is made in step S55, the storing-reading processor 19 of the store terminal 1 refers to the operating status of the group in the record having the skill name “Expertise 1” in the skill group management DB 1002 (see FIG. 7B). Thus, the determination unit 15 determines whether the operating status of the group is “Online” (S57).

When the determination unit 15 determines that the operating status of the group in the record having the skill name “Expertise 1” is not “Online” (NO in S57), the storing-reading processor 19 updates the operating status to “Online” (S58). Accordingly, when the display controller 14 displays a screen illustrated in FIG. 24A, the display controller 14 performs a normal display to display the skill name in a clearly viewable manner, such as “cruises” (S59). In contrast, when the determination unit 15 determines that the operating status of the group in the record having the skill name “Expertise 1” is “Online” (YES in S57), the storing-reading processor 19 does not update the operating status of the group in the record having the skill name “Expertise 1”. According to the process described above thus far, the operating status of the group in the record having the skill name “Expertise 1” in the skill group management DB 1002 becomes “Online”.

Since the skill names “Expertise 1, Expertise 2” are acquired in step S51, the storing-reading processor 19 updates records having the skill name “Expertise 2” in the skill group management DB 1002 in the loop process in the same manner.

Next, the operating status information (the operating status “Chat”, the skill name “Expertise 1, Expertise 2”, and the communication ID “01ba”) is transmitted from the explainer terminal 9ug11 to the store terminal 1, and the process when the operating status information is acquired in step S51 will be described (S52: Chat).

First, in the loop process, a process of updating a record having the skill name “Expertise 1” in the skill group management DB 1002 will be described. The storing-reading processor 19 of the store terminal 1 refers to a call-available field in the record having the skill name “Expertise 1” in the skill group management table of the skill group management DB 1002. Thus, the determination unit 15 determines whether the communication ID “01ba” acquired in step S51 is included in the field of the call (S63).

When the determination unit 15 determines that the communication ID “01ba” acquired in step S51 is included in the call-available field in the skill group management DB 1002 (S63: YES), the storing-reading processor 19 deletes the acquired communication ID “01ba” from the call-available field (S64).

When the processing of step S64 is completed or when the determination of NO is made in step S63, the storing-reading processor 19 of the store terminal 1 refers to the call in-progress field in the record having the skill name “Expertise 1” in the skill group management DB 1002. Accordingly, the storing-reading processor 19 determines whether the communication ID “01ba” acquired in step S51 is included in the call in-progress field (S65).

When the determination unit 15 determines that the communication ID “01ba” acquired in step S51 is not included in the call in-progress field in the skill group management DB 1002 (S65: NO), the acquired communication ID “01ba” is added to the call in-progress field (S66). As a result, the communication ID of the explainer terminal 9ug11 is recorded only in the call in-progress field in the record having the skill name “Expertise 1” in the skill group management DB 1002.

When step S66 is completed, or when YES is applied in step S65, the storing-reading processor 19 of the store terminal 1 refers to the call-available field in the record having the skill name “Expertise 1” in the skill group management DB 1002. Accordingly, the storing-reading processor 19 determines whether the number of communication IDs recorded in the call-available field in the record having the skill name “Expertise 1” is 0 (zero) (S67).

In step S68, when the number of communication IDs recorded in the call-available field in the record having the skill name “Expertise 1” is 0 (zero) (S67: YES), the storing-reading processor 19 updates the operating status of the group in the record having the skill name “Expertise 1” to “Chat”. Accordingly, when the screen illustrated in FIG. 24A is displayed, the display controller 14 implements semi-transparent display such as “weddings” for example (S69). In contrast, when the number of communication IDs recorded in the call-available field in the record having the skill name “Expertise 1” is not 0 (zero) (S67: NO), the storing-reading processor 19 does not update the operating status of the group in the record having the skill name “Expertise 1”. That is, when the communication ID is recorded in the call-available field in the record having the skill name “Expertise 1”, the corresponding operating status remains “Online” without being updated.

In step S51, since the skill names “Expertise 1, Expertise 2” are acquired, the storing-reading processor 19 updates each record having the skill name “Expertise 2” in the skill group management DB 1002 in the same manner.

Next, a case in which the operating status information (the operating status “Offline”, the skill names “Expertise 3, Expertise 4”, and the communication ID “01ca”) is transmitted from the explainer terminals 9ug21 to the store terminal 1, and the operating status information thereof is acquired in step S51 will be described (step S52: Offline).

First, a process of updating a record having the skill name “Expertise 3” in the skill group management DB 1002 in the loop process will be described. The storing-reading processor 19 of the store terminal 1 refers to the call-available field in the record having the skill name “Expertise 3” in the table of the skill group management DB 1002. Thus, the determination unit 15 determines whether the communication ID “01ca” acquired in step S51 is included in the call-available field (S73).

When the determination unit 15 determines that the communication ID “01ca” acquired in step S51 is included in the call-available field in the skill group management DB 1002 (S73; YES), the storing-reading processor 19 deletes the acquired communication ID “01ca” from the call-available field (S74).

When step S74 is completed or when the determination of NO is made in step S73, the storing-reading processor 19 of the store terminal 1 refers to the call in-progress field in the record having the skill name “Expertise 3” in the table of the skill group management DB 1002. Thus, the determination unit 15 determines whether the call in-progress field includes the communication ID “01ca” acquired in step S51 (S75).

When the determination unit 15 determines that the communication ID “01ca” acquired in step S51 is included in the call in-progress field in the skill group management DB 1002 (S75: YES), the acquired communication ID “01ca” is deleted from the call in-progress field (S76). Up to this point, the communication ID of the explainer terminal 9ug21 is deleted from the record having the skill name “Expertise 3” in the skill group management DB 1002.

When step S76 is completed or when the determination of NO is made in step S75, the storing-reading processor 19 of the store terminal 1 refers to the call-available field and the call in-progress field in the record having the skill name “Expertise 3” in the skill group management DB 1002. Accordingly, in step S77, the storing-reading processor 19 checks whether the condition IF1 or IF2 is satisfied. The condition IF1 indicates a condition in which the number of communication IDs recorded in the call-available field in the record having the skill name “Expertise 1” is 0 (zero), and the number of communication IDs recorded in the call in-progress field is not 0 (zero).

The condition IF2 indicates a condition in which the number of communication IDs recorded in the call-available field in the record having the skill name “Expertise 3” is 0 (zero) and the number of communication IDs recorded in the call in-progress field is 0 (zero).

When the number of communication IDs recorded in the call-available field in the record having the skill name “Expertise 3” is 0 (zero), and the number of communication IDs recorded in the call in-progress field is not 0 (S77: IF1), the storing-reading processor 19 updates the operating status of the group in the record having the skill name “Expertise 3” of the skill group management DB 1002 to “Chat” (S78). When the number of communication IDs recorded in the call-available field in the record having the skill name “Expertise 3” is 0 (zero), and the number of communication IDs recorded in the call in-progress field is 0 (S77: IF2), the storing-reading processor 19 updates the operating status of the group in the record having the skill name “Expertise 3” of the skill group management DB 1002 to “Offline” (S79). Accordingly, when the screen illustrated in FIG. 24A is displayed, the display controller 14 implements semi-transparent display such as “weddings” for example (S80). Meanwhile, in step S77, when neither IF1 nor IF2 is applicable (S77: NO), the storing-reading processor 19 does not update the operating status of the group in the record having the skill name “Expertise 3” to be “Online”.

Since the skill names “Expertise 3, Expertise 4” are acquired in step S51, the storing-reading processor 19 updates each record having the skill name “Expertise 4” in the skill group management DB 1002 in the loop process in the same manner.

### <Video Call Start Process>

Next, a process of starting a video call for a remote customer will be described with reference to FIGS. 24A to 24D and FIG. 25. FIGS. 24A to 24D are diagrams each illustrating a screen displayed by a store terminal. FIG. 25 is a sequence diagram illustrating a process of starting a video call.

In the store terminal 1, a display controller 14 displays any one of the screens illustrated in FIGS. 24A to 24D on a display 106 of the store terminal 1, and a reception unit 12 receives, from a customer, the selection of a skill group or designation of an explainer (S82).

Specifically, the storing-reading processor 19 acquires a combination of each skill name and operating status of the skill group associated with this skill name stored in the skill group management table (see FIG. 7B). Accordingly, the display controller 14 displays a skill selection screen illustrated in FIG. 24A on the display 106 of the store terminal 1.

On the right side of the skill selection screen are disposed skill display buttons (cruise, wedding, and the like) for selecting skills and an explainer list display button for displaying a list of all the explainer destinations. Here, a “Cruises” skill display button is normally displayed, enabling the customer to be ready to select. In contrast, a “Weddings” skill button is displayed semi-transparently, so as not to allow the customer to select. For example, when the customer selects the “Cruises” skill display button, the reception unit 12 receives the selection and the display controller 14 displays, on the display 106, a confirmation screen illustrated in FIG. 24B. When the customer clicks the “OK” button, the reception unit 12 receives the depression of the “OK” button. The below noted connection request information (see S84-1 and S85-1 below) indicating a communication session connection request for a video call is transmitted from the transmitter-receiver 11 to a desired one of the explainer terminals 9 through the communication management device 5.

Meanwhile, in the skill selection screen illustrated in FIG. 24A, when the customer clicks the explainer list display button, the reception unit 12 receives the clicking by the customer so that the display controller 14 displays the explainer destination list illustrated in FIG. 24C on the display 106, based on the explainer name, an operating status of the explainer terminal, and the skill name stored in the explainer management table (see FIG. 7A). When the customer selects the name of a desired explainer who uses the explainer terminal from among the call-available explainer terminals, and the customer clicks the “OK” button, the reception unit 12 receives the designation of the desired explainer, and the display controller 14 displays a confirmation screen illustrated in FIG. 24D on the display 106. When the customer clicks the “OK” button, the reception unit 12 receives the depression of the “OK” button and transmits a video call start request to the explainer terminal 9 designated by the transmitter-receiver 11 through the communication management device 5 (see S90 and the process in FIG. 26, which will be described later).

Subsequently, in the store terminal 1, when the customer selects a desired skill group (for example, a responsible organization capable of explaining about “cruises”) on the skill selection screen illustrated in FIG. 24A, the determination unit 15 determines whether to transmit the video call start request to the explainer terminal of the online (call-available) skill group (for example, cruise) of the unmanned store priority support organization UG1 or to transmit the video call start request to the explainer terminal of the online (call-available) skill group (for example, cruise) of the manned store priority support organization MG1 (for example, S83). In this case, the store terminal 1 determines based on the subgroup name to which the account ID of the store terminal 1 belongs in the subgroup management table (see FIG. 12B) in the service information received in step S19. When the store terminal 1 belongs to an unmanned store, the determination unit 15 determines a start request destination as a specific skill group of the unmanned store priority support organization UG1. When the store terminal 1 belongs to a manned store, the determination unit 15 determines the start request destination as a specific skill group of the manned store priority support organization MG1.

Next, a description is given of a case where when the store terminal 1 is the store terminal 1c2 installed in the unmanned store US, a video call start request (first transmission) is preferentially transmitted to the online (call-available) explainer terminals 9ug11 and 9ug12 in the organization SR21 in charge of skill SK1 in the unmanned store priority support organization UG1.

First, as the first transmission prior to the video call start request (see 5101 in FIG. 26), the transmitter-receiver 11 of the store terminal 1c2 transmits connection request information representing a communication session connection request for a video call all at once (S84-1). The connection request information includes a communication ID of which the corresponding operating status is “Online” from among the communication IDs read in step S83, a communication ID of the store terminal 1c2 acting as a start request source, and a skill name representing the skill selected in step S82.

Next, when the transmitter-receiver 51 of the communication management device 5 receives the connection request information transmitted by the store terminal 1c2, the transmitter-receiver 51 of the communication management device 5 transmits the video call start request to the explainer terminal 9ug11 specified by the communication ID included in the received connection request information (step S84-2).

When the operating status is updated in step S34 (see FIG. 22) in a period between the time at which the store terminal 1c2 transmits the connection request information and the time at which the store terminal 1c2 receives a response, the store terminal 1c2 repeats the processes of step S82 and step S83. Accordingly, when the operating status of the explainer terminal 9 is updated to “Online” and the communication ID is extracted as the communication ID associated with the operating status of “Online”, the transmitter-receiver 11 of the store terminal 1c2 transmits the connection request information including the communication ID to the communication management device 5 (step S85-1). The connection request information transmitted in this case includes a skill name representing the skill selected in step S82 and a communication ID of the store terminal 1c2.

In step S85-2, when the connection request information transmitted by the store terminal 1 is received, the transmitter-receiver 51 of the communication management device 5 transmits the connection request information to the explainer terminal 9ug12 specified by the communication ID included in the received connection request information.

The respective transmitter-receivers 91 of the explainer terminals 9ug11 and 9ug12 receive connection request information transmitted from the store terminal 1c2 through the communication management device 5. When the explainer terminals 9ug11 and 9ug12 receive this connection request information, the respective display controllers 14 of the explainer terminals 9ug11 and 9ug12 display a message including the request source information associated with the communication ID included in the connection request information and a skill name (skill information) associated with the skill name included in the call start request on the displays 106 of the explainer terminals 9ug11 and 9ug12. The explainers of the explainer terminals 9ug11 and 9ug12 are able to find in advance the travel products desired by the customer by displaying the skill in the message.

Next, when the explainer terminals 9ug11 and 9ug12 perform input operation of response permission, the reception units 92 of the explainer terminals 9ug11 and 9ug12 receive the input operation of the response permission (step S86-1 and step S86-2). When the reception units 92 of the explainer terminals 9ug11 and 9ug12 receive the input operation of the response permission, the respective transmitter-receivers 91 of the explainer terminals 9ug11 and 9ug12 transmit response information representing connection availability to the communication management device 5 (step S87-1 and step S87-2). This response information includes the communication ID of the transmission source (the store terminal 1c2) and the communication IDs of the explainer terminals (9ug11 and 9ug12). Accordingly, the transmitter-receiver 51 of the communication management device 5 receives the response information transmitted by the explainer terminals 9ug11 and 9ug12. The above-described process is an example, and the respective transmitter-receivers 11 of the explainer terminals 9ug11 and 9ug12 may automatically transmit response information to the store terminal 1c2 when connection request information is received from the store terminal 1c2. When multiple connection request information is received from a plurality of store terminals 1, the transmitter-receivers 11 of the explainer terminals 9ug11 and 9ug12 may transmit the response information to one of the store terminals 1 acting as a transmission source of the connection request information from which the transmitter-receivers 11 of the explainer terminals 9ug11 and 9ug12 have first received the connection request information.

Next, the transmitter-receiver 51 of the communication management device 5 transmits the received response information to the store terminal 1c2 specified by the communication ID included in the response information (step S87-2 and step S88-2).

When a plurality of response information pieces is received, the transmitter-receiver 11 of the store terminal 1c2 determines the explainer terminal 9 included in the first received response information as the transmission source (S89). Hereinafter, in the present embodiment, a case where the explainer terminal 9ug11 is included in the first received response information will be described.

The transmitter-receiver 51 of the communication management device 5 performs control to establish a communication session to make a video call while transmitting, through the relay device 3, content data of the image data and the sound data between the explainer terminal 9ug11 and the store terminal 1 specified by the communication IDs (the communication ID of the store terminal and the communication ID of the explainer) included in the communication establishment request (step S90). Step S90 will be described in detail later with reference to FIG. 26. The communication session may not be limited to the above-described session through the relay device 3 and may be a session for directly transmitting the content data between the explainer terminal 9ug11 and the store terminal 1c2 through the communication network 100. When communication between the store terminal 1c2 and the explainer terminal 9ug11 is established, the store terminal 1c2 and the explainer terminal 9ug11 transmit image data of images captured by the store terminal 1c2 and the explainer terminal 9ug11, and sound data collected by the store terminal 1c2 and the explainer terminal 9ug11 to the other terminal through the relay device 3. This enables a video call to be initiated between the customer and the explainer, as illustrated in FIG. 2.

When communication is established in step S90, the transmitter-receiver 91 of the explainer terminal 9ug11 transmits status information including the operating status “Chat”, the skill name “Expertise 1”, and the communication ID of the explainer terminal 9ug11 to the communication management device 5.

When the communication is established in step S90, the transmitter-receiver 11 of the store terminal 1c2 transmits cancel information to the communication management device 5 in order to cancel a call start request with respect to a transmission source of the response other than the transmission source of the first received response (step S91-1). The cancel information includes the communication ID of the store terminal 1c2 and the communication ID of the explainer terminal 9 (in this example, the explainer terminal 9ug12) acting as the transmission source other than the transmission source of the first received response.

When the transmitter-receiver 51 of the communication management device 5 receives cancel information, the cancel information is transmitted to the explainer terminal 9ug12 specified by the communication ID included in the cancel information (step S91-2). The transmitter-receiver 11 of the explainer terminal 9ug12 then receives the cancel information transmitted by the communication management device 5. Accordingly, the explainer terminal 9ug12 recognizes that explainer terminal 9ug12 does not need to respond to the call start request from the store terminal 1.

### <Communication Establishment Control Process>

Next, the communication establishment control process in FIG. 25 (see S90) will be described in detail with reference to FIG. 26. FIG. 26 is a sequence diagram illustrating a detailed process of communication establishment control.

First, the store terminal 1c2 transmits start request information representing a request for starting a video call to the communication management device 5 (step S101). The start request information includes the communication ID of the start terminal (in this example, the store terminal 1c2) and the communication ID of the explainer ug11 of the destination terminal (in this example, the explainer terminal 9ug11). As a result, the communication management device 5 receives the start request information.

Next, in the communication management device 5, the selector 53 selects the nearest relay device based on the respective IP addresses of the start terminal and the destination terminal (step S102). The IP addresses of the respective terminals are managed in the terminal management table, and the IP addresses of the relay devices are stored in advance in the storage unit 5000.

Next, the creator 54 creates communication information including the IP address, the communication ID, and the above-described connection ID of the relay device (step S103).

The storing-reading processor 59 stores and manages the connection ID as contents of the communication information in association with the IP address of the relay device and the respective communication IDs of the explainers of the start terminal and the destination terminal received in step S101 in the communication information management DB 5005 (see FIG. 9C) (S104).

Thereafter, the transmitter-receiver 51 transmits the start request information to the destination terminal (in this example, the explainer terminal 9ug11) (step S105). The start request information includes communication information (including the connection ID) in addition to the respective communication IDs of the explainers of the start terminal and the destination terminal transmitted from the start terminal in step S101. The transmitter-receiver 91a of the destination terminal receives the start request information in this manner.

Next, in the destination terminal, the determination unit 15 of the explainer terminal 9ug11 determines whether the communication ID of the start terminal (the store terminal 1c2) received in step S105 is the same as the communication ID of the store terminal 1c2 that has already received in step S84-2 in FIG. 25 (S106).

In this case, since the communication ID of the start terminal received in step S105 and the communication ID of the start terminal received in step S84-2 are basically the same, the transmitter-receiver 91a transmits response available information to the communication management device 5 (step S107). In this case, the response available information indicates that responding is possible, and includes the communication ID of the start terminal. The transmitter-receiver 51 of the communication management device 5 receives the response available information in this manner.

Next, the storing-reading processor 59 of the communication management device 5 searches the communication information management DB 5005 by using the communication ID of the start terminal received in step S107 as a search key, and reads the communication information (connection ID, communication ID, and IP address of the relay device) corresponding to the communication ID of the start terminal (step S108).

The transmitter-receiver 51 transmits response available information to the start terminal. In this case, the response available information includes communication information (including the connection ID) read in step S108. The transmitter-receiver 11 of the start terminal thus receives the response available information (S109).

Next, the transmitter-receiver 91 of the destination terminal transmits establishment request information representing a request to establish an intercommunication session to the IP address of the relay device included in the communication information received in step S105 (step S110). The establishment request information includes the communication ID of the start terminal and the communication ID of the explainer of the destination terminal. The IP address of the destination terminal acting as a transmission source is also transmitted.

Meanwhile, the transmitter-receiver 11 of the start terminal transmits establishment request information representing a request to establish an intercommunication session to the IP address of the relay device included in the communication information received in step S109 (step S111). The establishment request information includes the communication ID of the start terminal and the communication ID of the explainer of the destination terminal. The IP address of the start terminal acting as a transmission source is also transmitted.

As a result, a communication session for perform intercommunication of images and audio between the relay device 3 and the start terminal is established (step S112-1), and a communication session for perform intercommunication of images and audio between the relay device 3 and the destination terminal is also established (step S112-2).

Next, the transmitter-receiver 11 of the start terminal transmits status information of the store terminal 1c2 (the start terminal) to the communication management device 5 (step S113-1). This status information includes the communication ID and the operating status information (in this example, “a call in-progress”) of the start terminal. Thus, the transmitter-receiver 51 of the communication management device 5 receives the status information of the start terminal.

Meanwhile, the transmitter-receiver 91 of the destination terminal transmits status information of the explainer terminal 9 (the destination terminal) to the communication management device 5 (step S113-2). This status information includes the communication ID and the operating status information (in this example, “Chat (a call in-progress)”) of the destination terminal. Thus, the transmitter-receiver 51 of the communication management device 5 receives the status information of the destination terminal. As described above, each of the store terminal and the explainer terminal notifies the communication management device 5 of the operating status of a corresponding one of the store terminal and the explainer terminal.

In the communication management device 5, the storing-reading processor 59 changes, in the terminal management table (see FIG. 11A), the operating status associated with the communication ID of the start terminal to “Chat (a call in-progress)” and changes the operating status associated with the communication ID of the destination terminal to “Chat (a call in-progress)” (step S114).

Accordingly, the start terminal (the store terminal 1c2) and the destination terminal (the explainer terminal 9ug11) can make a video call by intercommunication, as illustrated in FIG. 2. The above-described process illustrates a case when a skill group such as “cruises” is selected in FIG. 24A in step S82.

<Video Call Start Request when Explainer is Designated>

Next, in step S82, a process of starting a video call when an explainer is designated as illustrated in FIG. 24C will be described. In this case, among processes from step S84 onward in FIG. 25, only the process in step S90 is performed.

When an explainer is designated, the processes of step S84-2 and step S85-2 in FIG. 25 are not performed. In step S106 of FIG. 26, the display controller 94 displays the communication ID of the start terminal, so that the designated explainer manually selects whether to respond or not. When the designated explainer selects whether to respond or not, the reception unit 92 receives the selection of whether to respond or not.

In processes in step S107 and step S109, response availability information (the selection of whether to respond or not) is transmitted instead of response available information as a result. In this case, the communication ID of the start terminal is also included in the response availability information. Since processes other than these processes are the same as the case when a skill group is selected, the description is omitted.

<Calling of Another Explainer Terminal from Explainer Terminal that Has Established Communication>

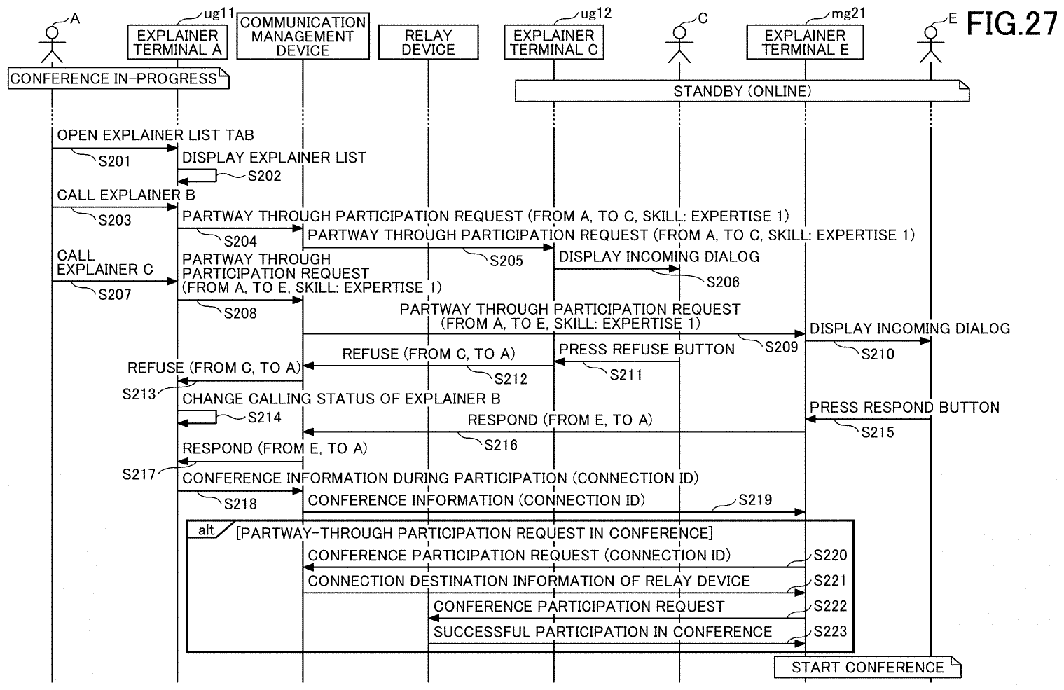

Next, a process of calling the explainer terminal 9ug12 from the explainer terminal 9ug11 will be described with reference to FIG. 27. FIG. 27 is a sequence diagram illustrating an example of a process of calling another explainer terminal from the explainer terminal 9 in communication with the store terminal 1. The explainer terminal 9 receives the explainer manager table (FIG. 7A) after startup. In addition, the explainer manager table of the explainer terminal 9 is updated in real time.

S201: The explainer A (explainer ug11) received questions from a customer while a call is in progress with the customer, and the explainer A considered that the explainer A would like to have a person who was familiar with the questions to join the call. The explainer A then performs an input operation with respect to the explainer terminal 9ug11 to display a list of explainers. The reception unit 92 of the explainer terminal 9ug11 receives the input operation.

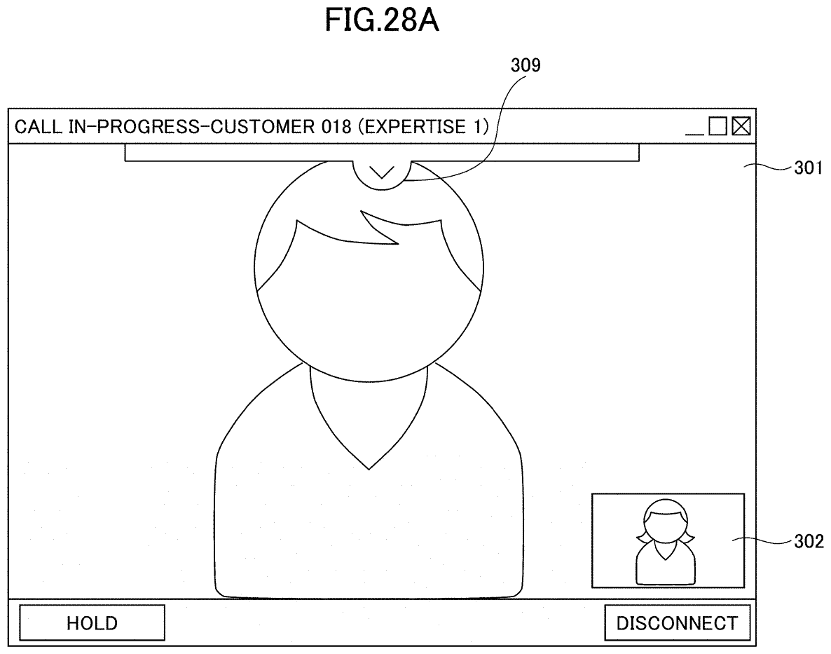

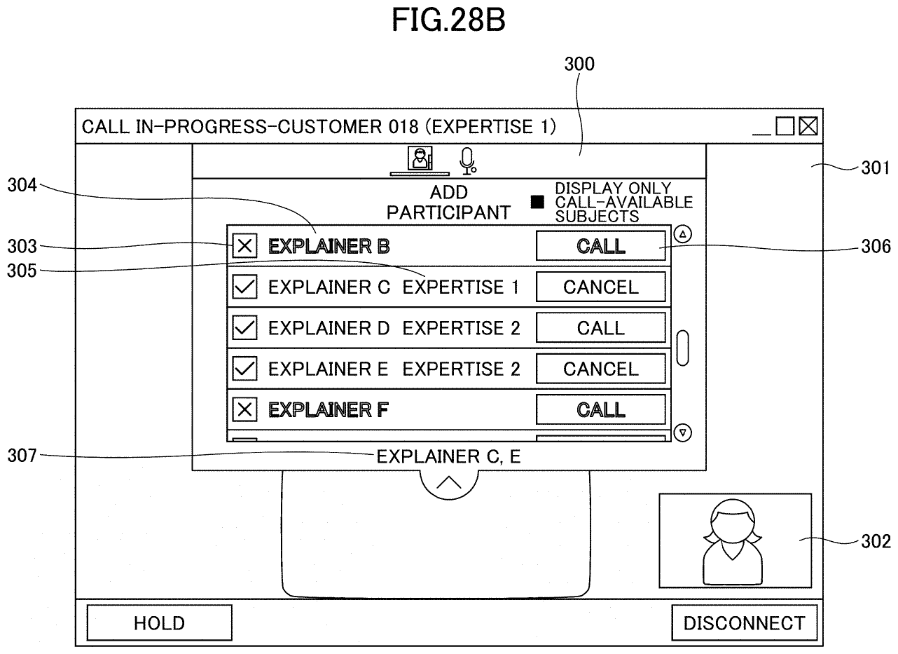

S202: Upon the input operation being received by the reception unit 92, the display controller 94 of the explainer terminal 9ug11 displays a list of explainers. The display controller 94 acquires the explainer manager table (FIG. 7A) through the storing-reading processor 99 and displays a list 300 of explainers (operating status and skills) other than the explainer A (explainer ug11). FIG. 28B illustrates an example of the list 300 of the other explainers.

S203: The explainer A considers the skills, and selects one of the other explainers (in this example, the explainer C (ug12)). The reception unit 92 of the explainer terminal 9ug11 receives the selection of the explainer (in this example, the explainer C (ug12)). The display controller 94 of the explainer terminal 9ug11 changes a calling status of the explainer C (the explainer terminal 9ug12) on the list of the other explainers. That is, the calling status of the explainer C is changed from “Call” to “Cancel”. “Cancel” is pressed in order to cancel the call.

S204: The transmitter-receiver 91 of the explainer terminal 9ug11 transmits to the communication management device 5 a partway-through participation request in a call. The partway-through participation request in a call includes the communication ID of a request source communication terminal (the explainer terminal 9ug11), the communication ID of the destination communication terminal (the explainer terminal 9ug12), and the required skill (the skill selected by the customer at the start of communication, i.e., the desired skill in FIG. 7A).

When the transmitter-receiver 91 transmits the partway-through participation request, a holding command may be automatically transmitted to the store terminal 1. When the store terminal 1 receives the holding command, the store terminal 1 may display a message such as “Please wait a moment” or an advertisement on the frontward of a video, or may mute the voice of the explainers (silence). This prevents the voice of the explainers from being transmitted to the store terminal 1, so that the customer will not hear internal conversation. The hold command may be transmitted by the operation of the explainer A. The holding status is canceled by the operation of the explainer A.

S205: The transmitter-receiver 51 of the communication management device 5 receives the partway-through participation request and transmits the partway-through participation request to the communication terminal (the explainer terminal 9ug12) of the destination.

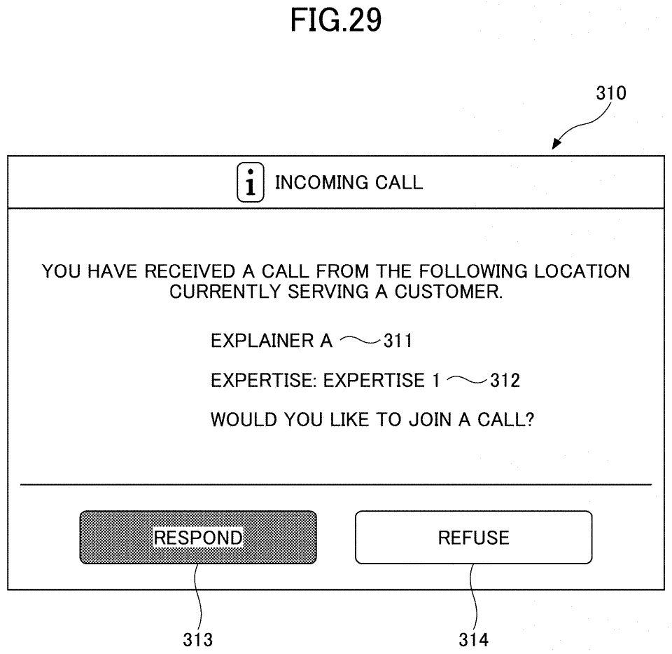

S206: The transmitter-receiver 91 of the explainer terminal 9ug12 receives the partway-through participation request, and the display controller 94 displays an incoming dialog. An example of the incoming dialog is illustrated in FIG. 29.

S207 to S210: The explainer ug11 can select a different one of the other explainers (here an explainer E (explainer mg21)) to execute the same processes as in steps S203 to S206. Since the explainer A can select two or more other explainers, the explainer A can be quickly supported by the other explainers. Note that the explainer A does not necessarily have to select two or more other explainers.

S211: When another the explainer C has refused the partway-through participation request by pressing a refuse button, the reception unit 92 of the explainer terminal 9ug12 receives the operation of refusal.

S212: The transmitter-receiver 91 of the explainer terminal 9ug12 transmits a refusal response to the communication management device 5. The refusal response includes the communication ID of the explainer terminal 9ug12 that has refused a partway-through participation request and the communication ID of the explainer terminal 9ug11 that has transmitted a partway-through participation request.

S213: The transmitter-receiver 51 of the communication management device 5 transmits the refusal response to the explainer terminal 9ug11 that has transmitted the partway-through participation request.

S214: The transmitter-receiver 91 of the explainer terminal 9ug11 receives the refusal response, and the display controller 94 changes the calling status of the explainer C (the explainer terminal 9ug12) on the list of the explainers. That is, the calling status is changed from currently calling status (displayed as “Cancel”) to “Call”.

S215: When the other explainer E responds to (accepts) a partway-through participation request by pressing a respond button, the reception unit 92 of the explainer terminal 9mg21 receives the operation of the response.

S216: The transmitter-receiver 91 of the explainer terminal 9mg21 transmits an acceptance response to the communication management device 5. The acceptance response includes the communication ID of the explainer terminal 9mg21 that has responded to the partway-through participation request and the communication ID of the explainer terminal 9ug11 that has transmitted the partway-through participation request.

S217: The transmitter-receiver 51 of the communication management device 5 transmits an acceptance response to the explainer terminal 9ug11 that has transmitted the partway-through participation request.

S218: The transmitter-receiver 91 of the explainer terminal 9ug11 receives the acceptance response and transmits the connection ID that is currently while a call is in progress to the communication management device 5. (see FIG. 9C). Note that the explainer terminal 9ug11 may specify the communication ID instead of the connection ID and request the communication management device 5 to transmit the connection ID. The communication management device 5 acquires the connection ID associated with the communication ID from the communication information management DB 5005.

S219: The transmitter-receiver 51 of the communication management device 5 transmits the connection ID of the communication in which the explainer terminal 9ug11 participates to the explainer terminal 9mg21.

S220: The transmitter-receiver 91 of the explainer terminal 9mg21 receives the connection ID and transmits a conference participation request to the communication management device 5. The conference participation request contains the connection ID.

S221: The transmitter-receiver 51 of the communication management device 5 receives the conference participation request and transmits the IP address of the relay device associated with the connection ID to the explainer terminal 9mg21 for joining the same call.

S222: As a result, the transmitter-receiver 91 of the explainer terminal 9mg21 can communicate with the relay device 3 to which the explainer terminal 9ug11 is connected. The transmitter-receiver 91 of the explainer terminal 9mg21 transmits the conference participation request to the relay device 3 by specifying the connection ID.

S223: The transmitter-receiver 31 of the relay device 3 transmits success of conference participation to the explainer terminal 9mg21. Thereafter, the transmitter-receiver 31 of the relay device 3 transmits video and audio between communication terminals having the same connection ID.

If another the explainer C does not refuse the partway-through participation request and responds to (accepts) the partway-through participation request, the explainers C and E can join the call together.

<List of Explainers Displayed on the Explainer Terminal Communicating with the Store Terminal>

FIG. 28B illustrates an example of the list 300 of explainers displayed on the explainer terminal 9ug11. As illustrated in FIG. 28A, the explainer terminal 9ug11 that is while a call is in progress initially displays an image 301 transmitted by the store terminal 1 and an image 302 (such as the face of the explainer) captured by the explainer terminal 9ug11.

When the explainer A (explainer ug11) requests the participation of another explainer, the explainer A presses a tab 309 with a mouse on a touch panel. As a result, as illustrated in FIG. 28B, the list 300 of other explainers is displayed.

The items displayed on the list 300 of other explainers are described. All the items on the list 300 of other explainers are obtained from the explainer manager table illustrated in FIG. 7A.

The icon 303 indicates whether another explainer can be called (online) or cannot be called (chat, offline). The other explainers who cannot be called are displayed in grayed out. The explainer name 304 indicates a name (title) of another explainer.

The skill 305 indicates a skill of another explainer. The calling status 306 indicates a status of the “Call” (the “Call” status means being ready to receive a call i.e., “call-available”) or “Cancel” (the “Cancel” status means being ready to cancel the call i.e., “call in-progress”). When the “Call” (call-available) is displayed, but the “Call” is disabled (chat or offline), the display is grayed out so that the explainer cannot press the call button.

The explainer terminal 9ug11 in a call in progress with the store terminal 1 is enabled to view a list of operating statuses (online, offline, chat) of the other explainers and a list of the skills of the other explainers on the list 300 of the other explainers. Thus, the explainer A can deduce which explainer should be selected and asked to participate in the call so as to satisfy the customer. The explainer A can select and call another explainer whom the explainer A would like to join the call from this list.

The explainer A can also call two or more other explainers in parallel. In FIG. 28B, the explainers C and E are being called in parallel. This can be determined based on the fact that the calling status 306 of the explainers C and E is “Cancel”, or that the explainers C and E are displayed as the explainers 307 currently being called at the bottom of the list 300 of the explainers.

When one of the other explainers (either C or E) has already participated in the call, and thus no longer requires the other one of the explainers to participate in the call, the explainer A can terminate the call of the other explainer by clicking the “cancel” button of the calling status 306.

The explainer A may be enabled to search for skills on the list 300 of explainers. That is, the explainer A can search for other explainers with the skills capable of answering to the customer's questions.

<Incoming Dialog Displayed by Another Explainer Terminal Called from the Explainer Terminal Communicating with the Store Terminal>

FIG. 29 is an example of an incoming dialog 310 displayed on another explainer terminal 9 called from the explainer terminal 9 in communication with the store terminal 1. Accordingly, the incoming dialog 310 is displayed by both the explainer terminal 9ug12 and the explainer terminal 9mg21.

The incoming dialog 310 includes an explainer name 311 of the explainer terminal 9ug11 that has transmitted the partway-through participation request and the skill 312 (desired skill) requested (selected) by the customer in the call made by the explainer terminal 9ug11. The explainers C and E can view the incoming dialog 310 to determine whether to join the call. For example, when the incoming dialog 310 displays the content (skill), such as “Hawaii travel” and “loan consultation”, mentioned while a call is in progress, the explainers C and E who will join partway through the call can easily understand and prepare what kind of content they need to prepare.

When the explainers C and E join a call, the explainers C and E press a respond button 313 to join partway through the call in which the explainer terminal 9ug11 is participating. When the explainers C and E click a refuse button 314, the communication management device 5 transmits a refusal response to the explainer terminal 9ug11, and a “Cancel” button representing currently making a call on the explanation list 300 is changed to a “Call” button again. As described above, the acceptance response or refusal response from the explainer C or E is displayed on the list 300 of explainers in real time.

Further, another skill may be displayed as the skill 312, in addition to the desired skill of FIG. 7A requested (selected) by the customer in the call made by the explainer terminal 9ug11, or in place of the desired skill. For example, the skill specified by the explainer A in the search result or the skills of the explainers C and E may be used. Any of these skills are expertise skills required for the other explainers. In addition, a desired free word input by the explainer A may be displayed.

<Display of a Change in the Operating Status of Another Explainer while a Call being in Progress into the List of Explainer>

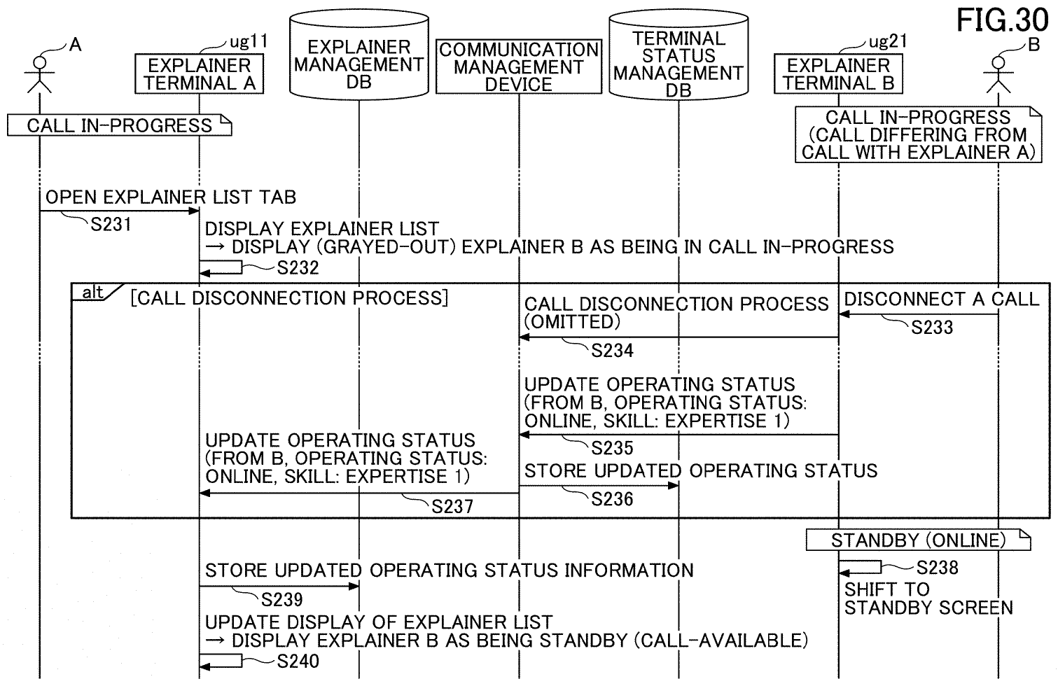

The explainer management table illustrated in FIG. 7A retained by each communication terminal is updated in real time. When the operating status of another explainer is changed while the explainer terminal 9ug11 that has transmitted the partway-through participation request displays the list of other explainers, the operating status of another explainer in the list 300 is changed in real time. Illustrated in the sequence diagram in FIG. 30.

FIG. 30 is a sequence diagram illustrating an example of a process in which the explainer terminal 9ug11 displays, in real time, a change in the operating status of another explainer while a call is in progress on the list 300 of the explainers.

S231 and S232: Similar to FIG. 27, the explainer terminal 9ug11 displays the list 300 of the other explainers according to the operation performed by the explainer A (the explainer ug11). Here, it is assumed that the other explainer B is unable to call (offline) or is in a call in progress (chat). Thus, information about the explainer B is displayed in a grayed-out manner on list 300 of the other explainers (FIG. 28B). In this state, the explainer A cannot click on the “Call” button for the explainer B.

S233: The other explainer B (explaining ug21) has disconnected the call.

S234: The transmitter-receiver 91 of the explainer terminal 9ug21 transmits a statement that the call is disconnected to the communication management device 5.

S235: The transmitter-receiver 91 of the explainer terminal 9ug21 transmits an updated operating status to the communication management device 5. The updated operating status includes the communication ID of the explainer terminal 9ug21, the operating status (online), and other explainer B's skills.

S236: The storing-reading processor 59 of the communication management device 5 performs processing such as changing of the operating status of the explainer terminal 9ug21 in the operating status management table or deleting of the communication ID from the session management table.

S237: The transmitter-receiver 51 of the communication management device 5 transmits an updated operating status of the explainer terminal 9ug21 to the explainer terminal 9ug11. The updated operating status of the explainer terminal 9ug21 is transmitted not only to the explainer terminal 9ug11 but also to all explainer terminals 9 having the operating status “online” or “chat”.

S238: The display controller 94 of the explainer terminal 9ug21 that has terminated a call displays a standby screen.

S239: The transmitter-receiver 91 of the explainer terminal 9ug11 receives an updated operating status of the explainer terminal 9ug21, and the storing-reading processor 99 updates the operating status of the explainer terminal 9ug21 in the explanation manager table in FIG. 7A. That is, the operating status is updated from chat to online.

S240: The explainer terminal 9ug11 of the display controller 94 updates the icon 303 on the list 300 of the explainers, and changes the “Call” button indicating the calling status 306 from the grayed-out state to a pressable state. This enables the explainer A to transmit a conference participation request to explainer B.

Note that unless the explainer terminal 9ug11 displays the list 300 of the explainers, the display controller 94 does not display the change in the explainer manager table to the list 300 of the explainers. This is because it is sufficient for the explainer A to know the operating statuses of the other explainers when the explainer A transmits a conference participation request.

However, there is a case where the explainer A is waiting for the operating status of another explainer having a certain skill to become online. In such a case, when the explainer terminal 9ug11 does not display the list 300 of the explainers, the display controller 94 may automatically display the list 300 of the explainers according to the updating of the operating statuses. However, it can be troublesome when the list 300 of the explainers is displayed every time all the explainer terminals are online. Thus, the explainer A may set whether or not to automatically display the list 300 of explainers.

As described above, the explainer terminal according to the present embodiment can display the operating statuses of other explainers in real time.

### <Major Effects>

As described above, the explainer terminal 9 according to the present embodiment can display a list of other explainer terminals 9 and call the selected other explainer terminal 9, which enables another explainer of the selected other explainer terminal 9 to join a call in progress between a customer and the explainer. In addition, the explainer terminal 9 conversing with a customer can display the operating status of another explainer in real time.

### <Other Applications>

While the preferred embodiments of the present invention have been described with reference to examples, various modifications and substitutions may be made thereto without departing from the spirit and scope of the invention.

For example, the configuration examples illustrated in FIGS. 5 and 6 are divided according to the main functions in order to facilitate understanding of the processing performed by the explainer terminal 9, the store terminal 1, and the communication management device 5. The invention of the present application is not limited by the method of dividing the processing unit or by name. The processing of the explainer terminal 9, the store terminal 1, and the communication management device 5 can be further divided into the number of processing units according to the processing contents. Alternatively, one processing unit can be split to include more processing.

Also, the devices described in the embodiments are merely indicative of one of a plurality of computing environments for carrying out the embodiments disclosed herein. In some embodiments, the communication management device 5 includes a plurality of computing devices such as a server cluster. The plurality of computing devices is configured to communicate with each other over any type of communication links, including networks, shared memory, and the like, and perform the processes disclosed herein.

Further, the communication management device 5 can be configured to share the disclosed processing steps, such as a flowchart illustrated in FIG. 27 and the like, in various combinations. For example, the processing performed by a predetermined unit may be performed by a plurality of information processing devices retained by the communication management device 5. The communication management device 5 may be organized into a single server device or may be divided into a plurality of devices.

The functions of the embodiments described above may also be implemented by one or more processing circuits. As used herein, a “processing circuit” includes a processor programmed to perform each function by software, such as a processor implemented in electronic circuits, an ASIC (Application Specific Integrated Circuit) designed to perform each function as described above, a digital signal processor (DSP), a field programmable gate array (FPGA), or a conventional circuit module.

The information processing device, the communication method, and the communication system are not limited to the specific embodiments described in the detailed description, and variations and modifications may be made without departing from the spirit and scope of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A communication method executed by an information processing device, the information processing device being configured to communicate with a second information processing device associated with a first user via a network, the information processing device including a processor, and a memory storing programmed instructions that, when executed by the processor, are operable for performing the communication method, the communication method comprising:
causing the information processing device to display a list of second users while a call is in progress with the second information processing device;
causing the information processing device to receive a selection of one of the second users displayed on the list; and
causing the information processing device to transmit a request for participation in the call with the second information processing device to a third information processing device, the third information processing device being associated with the selected one of the second users.

2. The communication method according to claim 1, wherein the list of second users includes information about a name and an attribute of each of the second users.

3. The communication method according to claim 2, wherein the information about the attribute is expertise possessed by a corresponding one of the second users.

4. The communication method according to claim 1, further comprising:
causing the information processing device to communicate with a communication management device via a network;
causing the information processing device to receive, from the communication management device, expertise and operating statuses of the second users retained by the communication management device; and
causing the information processing device to display, on the list of the second users, the expertise and the operating statuses of the second users received from the communication management device.

5. The communication method according to claim 4, further comprising:
causing the information processing device to receive expertise and operating statuses of the second users in real time from the communication management device; and
causing the information processing device to display, upon the operating statuses of the second users being updated while the list of the second users is being displayed, the updated operating statuses on the displayed list of the second users.

6. The communication method according to claim 3, further comprising:
causing the information processing device to transmit expertise required of the selected one of the second users to the selected one of the second users; and
causing the third information processing device associated with the selected one of the second users to display the expertise required of the selected one of the second users, the selected one of the second users being requested to join the call with the second information processing device.

7. The communication method according to claim 6, wherein the expertise required of the selected one of the second users is expertise required by the second information processing device.

8. The communication method according to claim 6, wherein the received expertise of the selected one of the second users is displayed on the list of the second users.

9. The communication method according to claim 1, further comprising:
causing the third information processing device to display a respond button for accepting to join a call with the second information processing device and a refuse button for refusing to join the call with the second information processing device;
causing the third information processing device to transmit an acceptance response to join the call with the second information processing device to the information processing device upon the third information processing device receiving a selection of the respond button; and
causing the information processing device to transmit information for joining a call between the information processing device and the second information processing device to the third information processing device.

10. The communication method according to claim 9, further comprising:
causing the third information processing device to transmit a refusal response to the information processing device upon the third information processing device receiving a selection of the refuse button; and
causing the information processing device to display on the list of second users the refusal response received from the third information processing device.

11. An information processing device configured to communicate with a second information processing device associated with a first user via a network, the information processing device comprising:
a processor; and
a memory storing programmed instructions that, when executed by the processor, are operable for causing the information processing device to
display a list of second users while a call is in progress with the second information processing device;
receive a selection of one of the second users displayed on the list; and
transmit a request for participation in the call with the second information processing device to a third information processing device, the third information processing device being associated with the selected one of the second users.

12. A communication system, comprising:
an information processing device configured to communicate with a second information processing device associated with a first user via a network; and
a communication management device configured to communicate with the information processing device,
wherein the communication management device includes a processor and a memory storing programmed instructions that, when executed by the processor, are operable for causing the communication management device to
store in a memory a user management DB, the user management DB including expertise and operating statuses of second users, and
transmit the expertise and the operating statuses of the second users stored in the user management DB to a third information processing device, the third information processing device being associated with one of the second users,
wherein the information processing device includes a processor and a memory storing programmed instructions that, when executed by the processor, are operable for causing the information processing device to
receive the expertise and the operating statuses of the second users from the communication management device via the network,
display a list of the second users while a call is in progress with the second information processing device,
receive a selection of one of the second users displayed on the list, and
transmit a request for participation in the call with the second information processing device to the third information processing device, the third information processing device being associated with the selected one of the second users.
